(19) United States
(12) Patent Application Publication
(10) Pub. No.: US 2025/0122417 A1
(43) Pub. Date: Apr. 17, 2025

(54) THERMALLY STABLE ADDITIVE FOR WELLBORE TREATMENTS

(71) Applicant: Halliburton Energy Services, Inc., Houston, TX (US)

(72) Inventors: William Cecil Pearl, Houston, TX (US); Samuel J. Lewis, Houston, TX (US); Aleksey Kolasnikov, Houston, TX (US)

(21) Appl. No.: 18/818,148

(22) Filed: Aug. 28, 2024

Related U.S. Application Data
(60) Provisional application No. 63/543,869, filed on Oct. 12, 2023.

(51) Int. Cl. C09K 8/467; C04B 24/26; C08F 220/56; C09K 8/42

(52) U.S. Cl. CPC C09K 8/467; C04B 24/2652; C08F 220/56; C09K 8/424; C08F 2800/10; C08F 2810/20

(57) ABSTRACT

A method for preparing a wellbore treatment fluid includes contacting a fluid with a high temperature suspension additive to form the wellbore treatment fluid. The high temperature suspension additive can be a reaction product of at least one monomer, a thermally unstable crosslinker, and a thermally stable crosslinker comprising a compound with at least four functional groups. Also, the high temperature suspension additive can maintain a viscosity of the wellbore treatment fluid at a temperature of at least 250° F. (121° C.) for at least about 4 hours with a viscosity equal to or greater than about 25% of a peak viscosity.

### CROSS REFERENCE TO RELATED APPLICATIONS

This application claims priority to U.S. Provisional Application No. 63/543,869 filed Oct. 12, 2023, entitled “Thermally Stable Additive for Wellbore Treatments,” which is incorporated by reference herein its entirety.

### BACKGROUND

During the drilling and completion of oil and gas wells, various wellbore treatments are performed on the wells for a number of purposes. For example, a wellbore is typically drilled down to the subterranean formation while circulating a drilling fluid through the wellbore. After the drilling is terminated, a string of pipe, e.g., casing, is run in the wellbore. Primary cementing is then usually performed whereby a cementing fluid, usually including water, cement, and particulate additives, is pumped down through the string of pipe and into the annulus between the string of pipe and the walls of the wellbore to allow the cementing fluid to set into an impermeable cement column and thereby seal the annulus. Subsequent secondary cementing operations, i.e., any cementing operation after the primary cementing operation, may also be performed. One example of a secondary cementing operation is squeeze cementing whereby a cementing fluid is forced under pressure to areas of lost integrity in the annulus to seal off those areas.

A variety of fluids are used in both drilling and completing the wellbore and in resource recovery. Example fluids include drilling fluid, also called mud, that is pumped into the wellbore during drilling and similar operations, spacer, which helps flush residual drilling fluid from the wellbore, cement, which typically lines at least part of the finished wellbore and is placed after flushing with a spacer, and fracturing fluids, which may be used to enhance oil or natural gas recovery. Although some parts of the wellbore lie near the surface, the majority are deep underground, where harsh conditions are found. In addition, problems with a downhole fluid can be difficult to detect or correct because the fluid may be far away from the surface and relatively inaccessible, particularly in the case of cement that has set and is no longer a fluid.

As the bottom hole circulating temperature of a well increases, the viscosity of a cementing fluid decreases. This decrease in viscosity, which is known as thermal thinning, can result in settling of the solids in the slurry. Undesirable consequences of the solids settling include free water and a density gradient in the set cement. To inhibit settling, cement suspending agents, e.g., crosslinked polymers, can be added to the cementing fluid. As the cementing fluid temperature increases, the cement suspending agent is thought to maintain or increase the viscosity of the cementing fluid, for example, by breaking at least part of the crosslinks to ensure that the polymer remains extended to provide stable viscosity. One important feature of a cement suspending agent is that it does not adversely affect low-temperature rheology. Existing cement suspending additives, e.g., guar or guar derivatives crosslinked with borate, delay crosslink breakage sufficiently to allow mixing and pumping of a cement fluid without imparting an excessively high viscosity. However, those existing suspension additives are known to degrade above 280° F. This temperature limitation makes these cement suspension additives impractical for use in higher temperature applications.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic illustration of the surface equipment according to some embodiments of the present disclosure used in placement of a spacer fluid and/or cement composition.

FIG. 2 is a schematic illustration of an example in which a spacer fluid including the thermally stable additive is used in between a cement composition and a drilling fluid.

FIG. 3 is a schematic illustration of an example in which a spacer fluid including the thermally stable additive is used in a wellbore.

FIG. 4 is a graph of the results of the on-off-on thickening time test for a slurry in accordance with some embodiments of the present disclosure.

FIG. 5 is a graph of the results of the on-off-on thickening time test for a slurry in accordance with some embodiments of the present disclosure.

FIG. 6 is a graph of a viscosity test for a slurry in accordance with some embodiments of the present disclosure.

FIG. 7 is a graph of a polymer viscosity longevity test.

FIG. 8 is a graphical depiction of the results of a thickening time test for a mixture made from 15 mL water in n-butanol and P* calculation for 7.9% wt./wt. H₂O and n-butanol.

FIG. 9 is a graphical depiction of the results of a thickening time test for a mixture made from 10 mL water in n-butanol and P* calculation for 5.3% wt./wt. H₂O and n-butanol.

FIG. 10 is a graphical depiction of the results of a thickening time test for a mixture made from 5 mL water in n-butanol and P* calculation for 2.6% wt./wt. H₂O and n-butanol.

FIG. 11 is a graphical depiction of the results of a thickening time test for a mixture made from 0 mL water in n-butanol and P* calculation for pure n-butanol.

FIG. 12 is a graphical depiction of the results of a thickening time test for a mixture made from 0 mL water in t-butanol and P* calculation for pure t-butanol.

FIG. 13 is a graphical depiction of the results of a thickening time test for a mixture made from 5 mL water in t-butanol and P* calculation for 2.6% wt./wt. H₂O and t-butanol.

FIG. 14 is a graphical depiction of the results of a thickening time test for a mixture made from 7.5 mL water in t-butanol and P* calculation for 7.9% wt./wt. H₂O and t-butanol.

FIG. 15 is a bar graph of the viscosity of various polymers made with varying amounts of water and n-butanol or t-butanol.

FIG. 16 is a graphical depiction of the results of viscosity and temperature over time for various polymers in sample cements in accordance with some embodiments of the present disclosure.

FIG. 17 is a graphical depiction of the results of viscosity and temperature over time for polymers in sample cements in accordance with some embodiments of the present disclosure.

### DETAILED DESCRIPTION

In the following detailed description of the illustrative embodiments, reference is made to the accompanying drawings that form a part hereof. These embodiments are described in sufficient detail to enable those skilled in the art to practice the invention, and it is understood that other embodiments may be utilized, and that logical structural, mechanical, electrical, and chemical changes may be made without departing from the spirit or scope of the invention. To avoid detail not necessary to enable those skilled in the art to practice the embodiments described herein, the description may omit certain information known to those skilled in the art. The following detailed description is, therefore, not to be taken in a limiting sense, and the scope of the illustrative embodiments is defined only by the appended claims.

As used herein, the term “percent” can be abbreviated “%”, the term “mole” can be abbreviated as “mol”, the term “mole percent” can be abbreviated “mol %”, the term “weight percent” can be abbreviated “wt. %”, the term “volume percent” can be abbreviated “vol. %”, the term “centipoise” can be abbreviated “cP”, the term “degrees Fahrenheit” can be abbreviated as “° F.”, the term “degrees Celsius” can be abbreviated as “° C.”, the term “revolutions per minute” can be abbreviated “rpm”, the term “minute” can be abbreviated “min”, the term “hour” can be abbreviated “hr”, the term “deciliter” can be abbreviated “dL”, the term “milliliter” can be abbreviated “mL”, the term “gram” can be abbreviated “g”, the term “natural log” can be abbreviated “Ln”, the term “pound” can be abbreviated “lb”, the term “kilogram” can be abbreviated “kg”, the term “gallon” can be abbreviated “gal”, the term “barrel” can be abbreviated “bbl”, the terms “meter” can be abbreviated “m” and “meter-cubed” can be abbreviated “m3”, the term “pound per gallon” can be abbreviated “ppg”, the term “pound per square inch” can be abbreviated “psi”, the term “beardan units of consistency” can be abbreviated “bc”, the term “by weight of cement” can be abbreviated “bwoc”, the term “by weight of spacer dry blend” can be abbreviated “bwob”, the term “by volume of the water” can be abbreviated “bvow”, the term “by weight of water” can be abbreviated “bwow”, the term “concentration” can be abbreviated “conc”, the term “average” can be abbreviated “Avg.”, the term “plastic viscosity” can be abbreviated “PV”, the term “yield point” can be abbreviated “YP”, the term “n-butanol” can be abbreviated “nBut”, and the term “t-butanol” can be abbreviated “Tert”.

As used herein, the term “mixture” can be a heterogenous association of two or more substances uniformly or irregularly dispersed, and can include a solution, a suspension, or a combination thereof.

As used herein, the term “acrylamide” can mean acrylamide or an acrylamide-based compound as disclosed below.

As used herein, in some embodiments, the term “thermally unstable crosslinker” can include a compound including at least one functional group and not more than three functional groups, and the term “thermally stable crosslinker” can include a compound including at least four functional groups.

As used herein, the “peak viscosity” can be determined with any suitable device, such as a high temperature viscometer or a high-pressure, high-temperature viscometer, of a treatment fluid or wellbore treatment fluid. In some embodiments, the peak viscosity can also be measured by yielding the polymer in water using any suitable heating or conditioning method, and measuring the viscosity either at temperature or any other desired temperature.

As used herein, the term “and/or” can mean one or more of items in any combination in a list, such as “A and/or B” means “A, B, or the combination of A and B”.

The present disclosure is directed to wellbore treatment fluids comprising a thermally stable additive, which may also be referred to alternatively as a high temperature suspension additive (HTSA). More particularly, the thermally stable additive may be included in wellbore treatment fluids such as in spacer fluids and cement slurries where thermal thinning may occur. The thermally stable additive may be advantageous in that it provides suspension of solids in subterranean formations that have bottom hole static temperatures (BHST) of 280° F. (138° C.) or greater, including those formations that have a bottom hole static temperature in excess of about 400° F. (204° C.). The thermally stable additives of the present disclosure are operable at significantly higher temperatures than conventional biopolymer-based suspension additives such as guar gum and xanthan gum. The thermally stable additives of the present disclosure are further advantageous over biopolymer-based suspension additives as the thermally stable additives do not adversely affect the low-temperature viscosity of a treatment fluid and allow for low temperature mixability as well as high temperature suspension.

In some embodiments, the thermally stable additive comprises a reaction product of a monomer, a thermally unstable crosslinker and a thermally stable crosslinker. In some embodiments, a thermally stable additive can be used as a viscosifier, and can be a polymer made from at least one monomer, typically two monomers, at least one thermally unstable crosslinker, at least one thermally stable crosslinker, and optionally an initiator. In some embodiments, the thermally stable additive has a polymer entanglement concentration (P*) in a range of about 0.001 g/dL to about 0.1 g/dL, about 0.001 g/dL to about 0.005 g/dL, about 0.005 g/dL to about 0.01 g/dL, about 0.01 g/dL to about 0.05 g/dL, or about 0.05 g/dL to about 0.1 g/dL.

In some embodiments, a thermally stable additive may include a polymer product of acrylamide, N-vinylpyrrolidone, a thermally unstable crosslinker comprising N,N-methylenebisacrylamide, and a thermally stable crosslinker comprising triallyl isocyanurate polymerized in a solvent system, such as a binary solvent system. Generally, the thermally unstable crosslinker has the property of hydrolyzing at a temperature above about 250° F. (121° C.) in a wellbore treatment fluid, and the thermally stable crosslinker which has the property of remaining hydrolytically stable at a temperature in a range of about 250° F. (121° C.) to about 450° F. (232° C.) in the wellbore treatment fluid for a period of at least about 1 hour. Often, the binary solvent system includes an alkanol and water.

In some embodiments, the binary solvent system can include a C₃-C₅ alkanol and water, a butanol and water, or t-butanol or n-butanol and water. The binary solvent system can include water in an amount ranging from greater than 0, about 1, about 2, about 3, or about 4 volume percent to less than or equal to about 10, about 9, about 8, about 7, about 6, or about 5 volume percent based on the total volume of the binary solvent system. Generally, the binary solvent system can include water in an amount ranging from greater than or equal to about 0.10, about 0.20, about 0.30, about 0.40, about 0.50, about 1.0, about 1.5, about 2.0, about 2.5, about 3.0, about 3.5, about 4.0, about 4.5, about 5.0, or about 5.5 volume percent to less than or equal to about 10, about 9.5, about 9.0, about 8.5, about 8.0, about 7.5, about 7.0, about 6.5, about 6.0, about 5.5, or about 5.0 volume percent based on the total volume of the binary solvent system. In some embodiments, the binary solvent system for t-butanol can include water in an amount ranging from greater than 0, about 1, about 2, about 3, or about 4 volume percent to less than or equal to about 6, about 5, about 4, or about 3 volume percent based on the total volume of the binary solvent system. In some embodiments, the binary solvent system for n-butanol can include water in an amount ranging from about 2, about 3, about 4, or about 5 volume percent to less than or equal to about 10, about 9, about 8, or about 7 volume percent based on the total volume of the binary solvent system.

In some embodiments, the binary solvent system comprises greater than 0 volume percent and less than or equal to about 10 volume percent water based on the total volume of the binary solvent system, and comprises greater than or equal to about 90 volume percent and less than about 100 volume percent t-butanol or n-butanol based on the total volume of the binary solvent system. Alternatively, the binary solvent system can include about 1 to about 5 volume or about 3 to about 5 volume percent water and about 95 volume percent to about 97 volume percent t-butanol based on the total volume of the binary solvent system, or about 4 to about 6 volume percent water and about 94 volume percent to about 96 volume percent n-butanol based on the total volume of the binary solvent system. In some embodiments, the thermally stable additive can be a high temperature suspension additive with a high temperature of at least 250° F. (121° C.), such as a range having a lower limit of about 250° F. (121° C.), of about 275° F. (135° C.), about 300° F. (149° C.), about 325° F. (163° C.), about 350° F. (177° C.), about 400° F. (204° C.), or about 450° F. (232° C.) to an upper limit of about 550° F. (288° C.), about 500° F. (260° C.), about 450° F. (232° C.), or about 400° F. (204° C.). Specific ranges include, but are not limited to, about 250° F. (121° C.) to about 550° F. (288° C.), about 250° F. (121° C.) to about 500° F. (260° C.), about 250° F. (121° C.) to about 450° F. (232° C.), about 250° F. (121° C.) to about 400° F. (204° C.), about 275° F. (135° C.) to about 550° F. (288° C.), about 275° F. (135° C.) to about 500° F. (260° C.), about 275° F. (135° C.) to about 450° F. (232° C.), about 275° F. (135° C.) to about 400° F. (204° C.), about 300° F. (149° C.) to about 550° F. (288° C.), about 300° F. (149° C.) to about 500° F. (260° C.), about 300° F. (149° C.) to about 450° F. (232° C.), about 300° F. (149° C.) to about 400° F. (204° C.), about 325° F. (163° C.) to about 550° F. (288° C.), about 325° F. (163° C.) to about 500° F. (260° C.), about 325° F. (163° C.) to about 450° F. (232° C.), about 325° F. (163° C.) to about 400° F. (204° C.), about 350° F. (177° C.) to about 550° F. (288° C.), about 350° F. (177° C.) to about 500° F. (260° C.), about 350° F. (177° C.) to about 450° F. (232° C.), about 350° F. (177° C.) to about 400° F. (204° C.), about 400° F. (204° C.) to about 550° F. (288° C.), about 400° F. (204° C.) to about 500° F. (260° C.), about 400° F. (204° C.) to about 450° F. (232° C.), about 450° F. (232° C.) to about 550° F. (288° C.), or about 450° F. (232° C.) to about 500° F. (260° C.).

Examples of the monomers may include, but are not limited to, one or more monomers selected from the group comprising acrylamide (Ac), methacrylamide, 2-acrylamido-2-methyl-1-propanesulfonic acid and salts thereof, N-vinylpyrrolidone (NVP), N-substituted acrylamides, N-substituted methacrylamides, N-methylacrylamide, N-ethylacrylamide, N-vinylcaprolactam, N,N-dimethylacrylamide, N,N-dimethylmethacrylamide, acrylic acid, methacrylic acid, acrylates (such as methyl acrylate and hydroxyethyl acrylate), methacrylates (such as methyl methacrylate, 2-hydroxyethyl methacrylate, and 2-dimethylaminoethyl methacrylate), and combinations thereof.

In some embodiments, the at least one monomer can include a first monomer comprising an acrylamide and a second monomer comprising N-vinylpyyrolidone.

Generally, the at least one monomer comprises a first monomer comprising an acrylamide and a second monomer comprising N-vinylpyyrolidone, and the acrylamide: N-vinylpyyrolidone mole ratio is about 0.1:99.9, about 1:99, about 5:95, about 10:90, about 20:80, about 25:75, about 30:70, about 40:60, or about 50:50, or about 99.9:0.1, about 99:1, about 95:5; about 90:10, about 80:20, about 75:25, about 70:30, or about 60:40. In some embodiments, the acrylamide: N-vinylpyyrolidone mole ratio is about 1:10 to about 99.9:1, about 1:1 to about 99:1, about 1:1 to about 20:1, about 1:1 to about 9:1, about 1:1 to about 4:1, about 1:1 to about 3:1, about 1:1 to about 2:1, about 1:1 to about 1.5:1, or about 1:1, or about 99.9:1 to about 1:10, about 99:1 to about 1:1, about 20:1 to about 1:1, about 9:1 to about 1:1, about 4:1 to about 1:1, about 3:1 to about 1:1, about 2:1 to about 1:1, or about 1:5:1 to about 1:1. In some embodiments, the at least one monomer comprises a first monomer comprising an acrylamide and a second monomer comprising N-vinylpyyrolidone, and the acrylamide: N-vinylpyyrolidone mole ratio is about 80:20, about 60:40, about 50:50, or about 40:60, or about 4:1 to about 1:4, about 1.5:1 to about 1:1.5, about 1.5:1 to about 1:1, or about 1:1 to about 1.5:1. In some embodiments, the at least one monomer is present in an amount ranging from about 0.1 mol % to about 99.9 mol %, about 0.1 mol % to about 1 mol %, about 1 mol % to about 5 mol %, about 5 mol % to about 10 mol %, about 10 mol % to about 25 mol %, about 25 mol % to about 50 mol %, about 50 mol % to about 75 mol %, about 75 mol % to about 90 mol %, about 90 mol % to about 99 mol %, or about 99 mol % to about 99.9 mol % based on total moles of the mixture.

The thermally unstable crosslinkers for use in the present disclosure may be a crosslinker with at least two, but no more than three acrylamide, methacrylamide, acrylate, methacrylate, vinyl or vinylidene ester, allyl ester groups, or combinations that is hydrolytically stable at ambient temperature and hydrolytically unstable at high temperature, i.e., above 250° F. (121° C.), on the timescale of the well treatment, such as a period of time of one hour or longer. As used herein, “hydrolytically stable,” and any derivative thereof, indicates stable against hydrolysis at a selected temperature for a selected period of time. A suitable thermally unstable crosslinker may hydrolyze at temperature at a point in a range from about 250° F. (121° C.) to about 550° C. (288° C.). Alternatively, at a point in a range of about 250° F. (121° C.) to about 350° F. (177° C.), about 350° F. (177° C.) to about 400° F. (204° C.), about 400° F. (204° C.) to about 500° F. (260° C.), about 500° F. (260° C.) to about 550° F. (288° C.), or any ranges therebetween.

The thermally unstable crosslinkers used in the methods and compositions of the present disclosure generally comprise one or more of the following crosslinkers: acrylamide-based crosslinkers, acrylate-based crosslinkers, ester-based crosslinkers, amide-based crosslinkers, any derivatives thereof, and any combinations thereof. These crosslinkers are stable at ambient temperatures, but will hydrolyze at higher temperatures and, as a result, causes the breaking of the crosslinking. In certain embodiments, the acrylamide-based crosslinkers may be monomers with at least one acrylamide or methacrylamide group, which may also contain additional unsaturated groups such as vinyl, allyl, and/or acetylenic groups. In certain embodiments, the acrylate-based crosslinkers may be monomers with at least one acrylate or methacrylate group, which may also contain additional unsaturated groups such as vinyl, allyl, and/or acetylenic groups.

Examples of acrylamide-based crosslinkers that may be suitable in certain embodiments of the present disclosure include, but are not limited to, N,N′-methylenebisacrylamide, N,N′-methylenebismethacrylamide, N,N′-ethylenebisacrylamide, N,N′-propylenebisacrylamide, and higher order derivatives, N,N′-(1,2-dihydroxyethylene)bisacrylamide, 1,4-diacryloylpiperazine, N,N-diallylacrylamide, and 1,3,5-triacryloylhexahydro-1,3,5-triazine.

Examples of acrylate-based crosslinkers that may be suitable in certain embodiments of the present disclosure include, but are not limited to, ethylene glycol di(meth)acrylate, propylene glycol di(meth)acrylate, diethylene glycol di(meth)acrylate, triethylene glycol di(meth)acrylate, polyethylene glycol di(meth)acrylate, 1,4-butanediol di(meth)acrylate, 1,6-hexanediol di(meth)acrylate, 1,1,1-trimethylolpropane trimethacrylate, pentaerythritol tri(meth)acrylate, pentaerythritol tetra(meth)acrylate, glycerol di(meth)acrylate, glycerol tri(meth)acrylate, triglycerol di(meth)acrylate, allyl (meth)acrylate, vinyl (meth)acrylate, tris [2-(acryloyloxy)ethyl] isocyanurate.

Examples of ester-based and amide-based crosslinkers that may be suitable in certain embodiments of the present disclosure include, but are not limited to, vinyl or allyl esters, such as diallyl carbonate, divinyl adipate, divinyl sebacate, N,N′-diallyltartardiamide, diallyl phthalate, diallyl maleate, and diallyl succinate.

In some embodiments, the at least one thermally unstable crosslinker comprises N, N-methylenebisacrylamide. In some embodiments, the at least one thermally unstable crosslinker is present in an amount ranging from about 0.1 mol % to about 20 mol %, about 0.1 mol % to about 1 mol %, about 1 mol % to about 2 mol %, about 2 mol % to about 3 mol %, about 3 mol % to about 4 mol %, about 4 mol % to about 5 mol %, about 5 mol % to about 10 mol %, about 10 mol % to about 15 mol %, or about 15 mol % to about 20 mol %, based on the total moles of the mixture.

In some embodiments, the thermally stable crosslinkers may be a crosslinker with at least two vinyl, vinylidene, or allyl groups, or combinations thereof that is hydrolytically stable in the wellbore treatment fluid under higher temperatures such as above about 250° F. (121° C.) to about 450° F. (232° C.), on the timescale of the well treatment, such as a period of time of one hour or longer. For example, the thermally stable crosslinkers may not hydrolyze or only partially hydrolyze where less than about 10% of the crosslinks hydrolyze in a treatment fluid at a temperature in a range of about 250° F. (93° C.) to about 450° F. (232° C.) for a period of at least about 1 hour. Alternatively, in a range of about 200° F. (93° C.) to about 300° F. (149° C.), about 300° F. (149° C.) to about 400° F. (204° C.), about 400° F. (204° C.) to about 450° F. (232° C.), or any ranges therebetween.

The thermally stable crosslinkers are typically ether-based and not amide- or ester-based. Unlike the amide- and ester-based crosslinkers, these crosslinkers are more resistant to thermal hydrolysis or even do not hydrolyze at high temperatures. Nonlimiting examples of thermally stable crosslinkers may include divinyl ether, diallyl ether, vinyl or allyl ethers of polyglycols or polyols (such as pentaerythritol tetraallyl ether (PEAE), allyl sucrose, ethylene glycol divinyl ether, triethylene glycol divinyl ether, diethylene glycol divinyl ether, glycerol diallyl ether, and polyethylene glycol divinyl ether, propylene glycol divinyl ether, and trimethylolpropane diallyl ether), divinylbenzene, 1,3-divinylimidazolidin-2-one (also known as 1,3-divinylethyleneurea or divinylimidazolidone), divinyltetrahydropyrimidin-2 (1H)-one, dienes (such as 1,7-octadiene and 1,9-decadiene), allyl amines (such as triallylamine and tetraallylethylene diamine), N-vinyl-3 (E)-ethylidene pyrrolidone, ethylidene bis(N-vinylpyrrolidone), triallyl isocyanurate (TTT), and any combination of any of the foregoing.

In some embodiments, the at least one thermally stable crosslinker can include triallyl isocyanurate. In some embodiments, the at least one thermally stable crosslinker is present in an amount ranging from about 0.1 mol % to about 20 mol %, about 0.1 mol % to about 1 mol %, about 1 mol % to about 2 mol %, about 2 mol % to about 3 mol %, about 3 mol % to about 4 mol %, about 4 mol % to about 5 mol %, about 5 mol % to about 10 mol %, about 10 mol % to about 15 mol %, or about 15 mol % to about 20 mol %, based on the total moles of the mixture.

In some embodiments, the mixture can include an initiator to facilitate a polymerization reaction, and be a compound including at least one of an azo group, a persulfate group, or a combination thereof. As an example, an initiator in an amount of about 0.001 wt. % to about 2 wt. %, 0.01 wt. % to about 1 wt. %, about 0.1 wt. % to about 0.9 wt. %, about 0.2 wt. % to about 0.8 wt. %, about 0.3 wt. % to about 0.7 wt. %, or about 0.4 wt. % to about 0.6 wt. %, based on the total weight of the mixture. In some embodiments, the initiator in an amount of about 0.01 wt. % to 1 wt. % or about 0.01 wt. % to about 0.1 wt. %, based on the total weight of the mixture. One exemplary initiator is azobisisobutyronitrile (AIBN), which may provide better control of the polymerization reaction.

A binary solvent system can include a two-phase solvent, or be referred to as a binary solvent. In some embodiments, the binary solvent system can include an alkanol and water, a C₃-C₅ alkanol and water, a butanol and water, or t-butanol or n-butanol and water, forming an organic or alkanol phase and a water phase. The water can be potable water or deionized water. In some embodiments, the potable water has less than or equal to about 1.0 wt. %, about 0.1 wt. %, about 0.01 wt. %, about 0.001 wt. %, or about 0.0001 wt. % other components, such as barium, copper, fluoride, and/or nitrate. In some embodiments, the deionized water has mineral ions removed, such as cations like sodium, calcium, iron, and copper, and anions such as chloride and sulfate, and can have less than or equal to about 0.1 wt. %, about 0.01 wt. %, about 0.001 wt. %, or about 0.0001 wt. % other components.

In some embodiments, the water can be in an amount ranging from greater than 0, about 1, about 2, about 3, or about 4 to less than or equal to about 10, about 9, about 8, about 7, about 6, or about 5 volume percent water based on the total volume of the binary solvent system. In some embodiments, the binary solvent system can include water in an amount ranging from greater than or equal to about 0.10, about 0.20, about 0.30, about 0.40, about 0.50, about 1.0, about 1.5, about 2.0, about 2.5, about 3.0, about 3.5, about 4.0, about 4.5, about 5.0, or about 5.5 to less than or equal to about 10, about 9.5, about 9.0, about 8.5, about 8.0, about 7.5, about 7.0, about 6.5, about 6.0, or about 5.5 volume percent based on the total volume of the binary solvent system. In some embodiments, the binary solvent system may include water in an amount ranging from greater than 0 volume percent to less than or equal to about 10 volume percent water based on the total volume of the binary solvent system and comprises t-butanol or n-butanol in an amount ranging from greater than or equal to about 90 volume percent to less than about 100 volume percent based on the total volume of the binary solvent system. In some embodiments, the binary solvent system comprises about 1 volume percent to about 6 volume percent or about 2 volume percent to about 6 volume percent water and about 94 volume percent or about 99 volume percent or about 94 volume percent to about 98 volume percent t-butanol based on the total volume of the binary solvent system, or about 3 volume percent to about 8 volume percent water based on the total volume of the binary solvent system and about 92 volume percent to about 97 volume percent n-butanol based on the total volume of the binary solvent system.

The thermally stable additive may have a polymer entanglement concentration (P*) in a range of about 0.001 g/dL to about 0.1 g/dL. Alternatively, in a range of about 0.001 g/dL to about 0.005 g/dL, about 0.005 g/dL to about 0.01 g/dL, about 0.01 g/dL to about 0.05 g/dL, about 0.05 g/dL, to about 0.1 g/dL, or any ranges therebetween. In some embodiments, the polymerization product may be insoluble in water.

The one or more monomers may be present in the thermally stable additive in an amount ranging from about 0.1 mol % to about 99.9 mol %. Alternatively, in an amount ranging from about 0.1 mol % to about 1 mol %, about 1 mol % to about 5 mol %, about 5 mol % to about 10 mol %, about 10 mol % to about 25 mol %, about 25 mol % to about 50 mol %, about 50 mol % to about 75 mol %, about 75 mol % to about 90 mol %, about 90 mol % to about 99 mol %, about 99 mol % to about 99.9 mol %, or any ranges therebetween. The thermally stable additive may include a combination of two or more monomers. When present, the two or more monomers may be included in a mole ratio ranging from a lower limit of about 0.1:99.9, about 1:99, about 5:95, about 10:90, about 20:80, about 25:75, about 30:70, about 40:60, or about 50:50 to an upper limit of about 99.9:0.1, about 99:1, about 90:10, about 80:20, about 75:25, about 70:30, about 60:40, or about 50:50, and wherein the amount may range from any lower limit to any upper limit and encompass any subset between the upper and lower limits and any lower limit may be combined with any other lower limit to recite a range not explicitly recited. In some embodiments, the acrylamide and the N-vinylpyrrolidone are present in a mole ratio of about 80:20, about 60:40, about 50:50, or about 40:60. In embodiments, the acrylamide and the 2-acrylamido-2-methyl-1-propanesulfonic acid are present in a mole ratio of about 80:20, about 60:40, about 50:50, or about 40:60. In other embodiments, the 2-acrylamido-2-methyl-1-propanesulfonic acid and the N-vinylpyrrolidone are present in a mole ratio of about 80:20, about 60:40, about 50:50, or about 40:60.

The thermally stable additive may include a thermally unstable crosslinker in an amount ranging from a lower limit of about 0.1 mol % to about 20 mol %. Alternatively, in a range of about 0.1 mol % to about 1 mol %, about 1 mol % to about 2 mol %, about 2 mol % to about 3 mol %, about 3 mol % to about 4 mol %, about 4 mol % to about 5 mol %, about 5 mol % to about 10 mol %, about 10 mol % to about 15 mol %, about 15 mol % to about 20 mol %, or any ranges therebetween. In one or more embodiments, N,N′-methylenebisacrylamide (MBA) is present in an amount from about 0.5 mol % to about 10 mol %, or from about 1.5 mol % to about 2.5 mol %, or about 2 mol %, or about 1 mol %.

The thermally stable additive may include a thermally stable crosslinker in an amount from a lower limit of about 0.1 mol % to about 20 mol. %. Alternatively, in a range of about 0.1 mol % to about 1 mol %, about 1 mol % to about 2 mol %, about 2 mol % to about 3 mol %, about 3 mol % to about 4 mol %, about 4 mol % to about 5 mol %, about 5 mol % to about 10 mol %, about 10 mol % to about 15 mol %, about 15 mol % to about 20 mol %, or any ranges therebetween.

In one or more embodiments, triallyl isocyanurate (TTT) is present in an amount ranging from about 0.5 mol % to about 10 mol %, or from about 1 mol % to about 5 mol %, or about 2 mol % to about 4 mol %. In embodiments, pentaerythritol tetraallyl ether (PEAE) is present in an amount ranging from about 0.5 mol % to about 10 mol %, or from about 1 mol % to about 5 mol %, or about 2 mol % to about 4 mol %. In some embodiments, triethylglycol divinyl ether (TEGDVE) is present in an amount ranging from about 0.5 mol % to about 10 mol %, or from about 1 mol % to about 5 mol %, or about 2 mol % to about 4 mol %.

In some embodiments, the thermally stable additive may be used in a wellbore and/or subterranean formation with a bottom hole static temperature (BHST) ranging from a lower limit of about 250° F. (121° C.), about 275° F. (135° C.), about 300° F. (149° C.), about 325° F. (163° C.), about 350° F. (177° C.), about 400° F. (204° C.), or about 450° F. (232° C.) to an upper limit of about 550° F. (288° C.), about 500° F. (260° C.), about 450° F. (232° C.), or about 400° F. (204° C.), and wherein the temperature may range from any lower limit to any upper limit and encompass any subset between the upper and lower limits.

In some embodiments, a method can include preparing a thermally stable additive, including contacting at least one monomer, at least one thermally unstable crosslinker, and at least one thermally stable crosslinker with a binary solvent system to form a mixture; and reacting the at least one monomer, the at least one thermally unstable crosslinker, and the at least one thermally stable crosslinker in a reaction zone under conditions suitable to produce the thermally stable additive. Initially, the mixture can be a two-phase solvent, and after polymerization, the mixture can form a suspension with the polymerization particles separating from the liquid. The thermally stable additive can increase viscosity of a wellbore treatment fluid at a high temperature by about two to about twelve times higher, alternatively by about four to about eight times higher, as compared to a suspension additive comprising the at least one monomer, the at least one thermally unstable cross linker, and the at least one thermally stable cross linker prepared in a single solvent system.

The binary solvent system, at least one monomer, at least one thermally unstable crosslinker, at least one thermally stable crosslinker, and initiator can be as described herein for preparing the thermally stable additive. The polymerization can occur with an acrylamide: N-vinylpyyrolidone mole ratio of about 0.1:about 99.9, about 1:about 99, about 5:about 95, about 10:about 90, about 20:about 80, about 25:about 75, about 30:about 70, about 40:about 60, or about 50:about 50, or about 99.9:about 0.1, about 99:about 1, about 95:about 5, about 90:about 10, about 80:about 20, about 75:about 25, about 70:about 30, or about 60:about 40, for about 2 to about 20 hours, about 3 to about 18 hours, about 4 to about 16 hours, about 8 to about 12 hours, or about 10 hours. In some embodiments, the polymerization can occur with an acrylamide: N-vinylpyyrolidone mole ratio of about 60:about 40 for about 2 to about 20 hours, about 3 to about 18 hours, about 4 to about 16 hours, about 8 to about 12 hours, or about 10 hours. Alternatively, the polymerization can occur with an acrylamide: N-vinylpyyrolidone mole ratio of about 1:10 to about 99.9:1, about 1:1 to about 99:1, about 1:1 to about 20:1, about 1:1 to about 9:1, about 1:1 to about 4:1, about 1:1 to about 3:1, about 1:1 to about 2:1, about 1:1 to about 1.5:1, or about 1:1, or about 99.9:1 to about 1:10, about 99:1 to about 1:1, about 20:1 to about 1:1, about 9:1 to about 1:1, about 4:1 to about 1:1, about 3:1 to about 1:1, about 2:1 to about 1:1, or about 1:5:1 to about 1:1, for about 2 to about 20 hours, about 3 to about 18 hours, about 4 to about 16 hours, about 8 to about 12 hours, or about 10 hours. In some embodiments, the polymerization can occur with an acrylamide: N-vinylpyyrolidone mole ratio of about 60:40 to about 40:60 for about 2 to about 20 hours, about 3 to about 18 hours, about 4 to about 16 hours, about 8 to about 12 hours, or about 10 hours. The polymerization temperature can be about 20° C. to about 80° C., about 30° C. to about 70° C., about 40° C. to about 60° C., or about 50° C. Any suitable pressure can be utilized, such as atmospheric. A weight of the binary solvent system is about 5 to about 15 times a sum of a weight of the at least one monomer, the at least one thermally unstable crosslinker, the at least one thermally stable crosslinker, and an initiator, based on a total weight of the mixture. Generally, the at least one thermally stable additive can be recovered by filtration. The thermally stable additive can have a polymer entanglement concentration as described herein.

In some embodiments, a method can include preparing a thermally stable additive, including contacting an acrylamide, N-vinylpyyrolidone, N, N-methylenebisacrylamide, and triallyl isocyanurate with a binary solvent system to form a mixture, and reacting the acrylamide, N-vinylpyyrolidone, N, N-methylenebisacrylamide, and triallyl isocyanurate to produce the thermally stable additive. The thermally stable additive may increase viscosity of a wellbore treatment fluid at a high temperature of about four to about eight times higher as compared to a suspension additive comprising the acrylamide, N-vinylpyyrolidone, N, N-methylenebisacrylamide, and triallyl isocyanurate prepared in a single solvent system or a solvent absent water, and the binary solvent system can include about 3 volume percent to about 5 volume percent water and about 95 volume percent to about 97 volume percent t-butanol based on a total volume of the binary solvent system, or about 4 to about 6 volume percent water and about 94 volume percent to about 96 volume percent n-butanol based on a total volume of the binary solvent system.

Once partially hydrolyzed at wellbore conditions, the high temperature crosslinker may provide viscosity to the fluid such that the fluid has a viscosity in a range of about 5 bc (beardan units of consistency—as measured in a pressurized consistometer in accordance with API RP 10B-2, Recommended Practice for Testing Well Cements, First Edition, July 2005) to about 120 bc. Alternatively, from about 5 bc to about 10 bc, about 10 bc to about 25 bc, about 25 bc to about 50 bc, about 50 bc to about 75 bc, about 75 bc to about 100 bc, about 100 bc to about 120 bc, or any ranges therebetween. Also, the fluid containing the hydrolyzed thermally stable additive may have a viscosity as measured by a viscometer in accordance with API RP 10B-2, Recommended Practice for Testing Well Cements, First Edition, July 2005) in a range of about 100 cP (centipoise) to about 600 cP. Alternatively, the hydrolyzed thermally stable additive may have a viscosity from about 100 cP to about 200 cP, about 200 cP to about 300 cP, about 300 cP to about 400 cP, about 400 cP to about 500 cP, about 500 cP to about 600 cP, or any ranges therebetween.

In some embodiments, the thermally stable additive can be included to a wellbore treatment fluid at about 0.1 wt. % to about 2 wt. %, or about 1 wt. %, and the wellbore treatment fluid may have a viscosity in a range of greater than or equal to about 100 cP, about 200 cP, about 300 cP, about 400 cP, about 500 cP, or about 600 cP to less than or equal to about 5,000 cP, about 4,800 cP, about 4,600 cP, about 4,400 cP, about 4,200 cP or about 4,000 cP.

In some other embodiments, the thermally stable additive comprises a reaction product of a monomer, a thermally unstable crosslinker and a thermally stable crosslinker, where the thermally stable crosslinker, where the thermally unstable and stable crosslinkers can be characterized by the number of functional groups, such as double bonds, including ethene bonds, in a compound (e.g., a compound having 2, 3, or 4 functional groups or a combination of such multi-functional compounds). In some aspects, the thermally stable crosslinker has four functional groups and at least some of the four functional groups provide cross-linking of the monomer in a polymer chain (e.g., polymer chains formed during polymerization of the one or more monomers described herein), and/or some of the thermally stable crosslinker (e.g., a plurality of individual cross-linker molecules) forms at least four single bonds with adjacent groups (e.g., wherein the adjacent groups are located on polymer chains and single bonds crosslink the polymer chains). In some embodiments, a thermally stable additive can be used as a viscosifier, and can be a polymer made from at least one monomer, typically two monomers, at least one thermally unstable crosslinker, at least one thermally stable crosslinker, and optionally an initiator. As an example, thermally unstable crosslinkers can have no more than three double bonds and thermally stable crosslinkers can have four or more double bonds. In some embodiments, the high temperature suspension additive has an operative temperature range greater than a high temperature suspension additive crosslinked with a thermally stable crosslinker absent a compound with at least four functional groups.

In some embodiments, a high temperature suspension additive comprising a polymer product of acrylamide, N-vinylpyyrolidone, thermally unstable crosslinkers comprising N, N-methylenebisacrylamide and triallyl isocyanurate, and a thermally stable crosslinker comprising pentaerythritol tetraallyl ether (PEAE), polymerized in a two-phase solvent. Generally, the high temperature suspension additive maintains viscosity of a wellbore treatment fluid at a high temperature for at least about 4 hours with a viscosity no less than about 25%, about 13%, or about 9.0% of a peak viscosity.

In some embodiments, the reaction product can be formed in a two-phase solvent (e.g., comprising an alkanol and water). The two-phase solvent can include a C₃-C₅ alkanol, such as a butanol, particularly t-butanol or n-butanol. The two-phase solvent can include greater than 0, about 1, about 2, about 3, or about 4 and less than or equal to about 10, about 9, about 8, about 7, about 6, or about 5 volume percent water based on a total volume of the two-phase solvent. Generally, the two-phase solvent can include greater than or equal to about 0.10, about 0.20, about 0.30, about 0.40, about 0.50, about 1.0, about 1.5, about 2.0, about 2.5, about 3.0, about 3.5, about 4.0, about 4.5, about 5.0, or about 5.5 and less than or equal to about 5.5, about 6.0, about 6.5, about 7.0, about 7.5, about 8.0, about 8.5, about 9.0, about 9.5, or about 10 volume percent water based on a total volume of the two-phase solvent. In some aspects, the two-phase solvent can include greater than 0 volume percent and less than or equal to about 10 volume percent water based on the total volume of the two-phase solvent and comprises greater than or equal to about 90 volume percent and less than about 100 volume percent t-butanol or n-butanol based on a total volume of the two-phase solvent. The two-phase solvent comprises about 3 to about 5 volume percent water and a balance t-butanol based on a total volume of the two-phase solvent, or about 4 to about 6 volume percent water based on the total volume of the two-phase solvent and a balance n-butanol based on the total volume of the two-phase solvent.

Generally, the thermally unstable crosslinker has the property of hydrolyzing at a temperature above about 250° F. (121° C.) in a wellbore treatment fluid, and the thermally stable crosslinker which has the property of remaining hydrolytically stable at a temperature in a range of about 250° F. (121° C.) to about 450° F. (232° C.) in the wellbore treatment fluid for a period of at least about 1 hour. Often, the binary solvent system includes an alkanol and water, as described herein. In some aspects, the high temperature has a lower limit of about 275° F. (135° C.), about 300° F. (149° C.), about 325° F. (163° C.), about 350° F. (177° C.), about 400° F. (204° C.), or about 450° F. (232° C.) to an upper limit of about 550° F. (288° C.), about 500° F. (260° C.), about 450° F. (232° C.), or about 400° F. (204° C.).

Thermally unstable crosslinkers can be those described herein having at least one functional group and no more than three functional groups, such as three double bonds, such as divinyl ether, diallyl ether, vinyl or allyl ethers of polyglycols or polyols (such as ethylene glycol divinyl ether, triethylene glycol divinyl ether, diethylene glycol divinyl ether, glycerol diallyl ether, and polyethylene glycol divinyl ether, propylene glycol divinyl ether, and trimethylolpropane diallyl ether), divinylbenzene, 1,3-divinylimidazolidin-2-one (also known as 1,3-divinylethyleneurea or divinylimidazolidone), divinyltetrahydropyrimidin-2 (1H)-one, dienes (such as 1,7-octadiene and 1,9-decadiene), allyl amines (such as triallylamine), N-vinyl-3 (E)-ethylidene pyrrolidone, ethylidene bis(N-vinylpyrrolidone), triallyl isocyanurate (TTT), and any combination of any of the foregoing. Other thermally unstable crosslinkers can include acrylamide-based crosslinkers that may be suitable in certain embodiments of the present disclosure include, but are not limited to, N,N′-methylenebisacrylamide, N,N′-methylenebismethacrylamide, N,N′-ethylenebisacrylamide, N,N′-propylenebisacrylamide, and higher order derivatives, N,N′-(1,2-dihydroxyethylene)bisacrylamide, 1,4-diacryloylpiperazine, N,N-diallylacrylamide, and 1,3,5-triacryloylhexahydro-1,3,5-triazine. Thermally unstable crosslinkers may also include acrylate-based crosslinkers that may be suitable in certain embodiments of the present disclosure include, but are not limited to, ethylene glycol di(meth)acrylate, propylene glycol di(meth)acrylate, diethylene glycol di(meth)acrylate, triethylene glycol di(meth)acrylate, polyethylene glycol di(meth)acrylate, 1,4-butanediol di(meth)acrylate, 1,6-hexanediol di(meth)acrylate, 1,1,1-trimethylolpropane trimethacrylate, pentaerythritol tri(meth)acrylate, glycerol di(meth)acrylate, glycerol tri(meth)acrylate, triglycerol di(meth)acrylate, allyl (meth)acrylate, vinyl (meth)acrylate, tris [2-(acryloyloxy)ethyl] isocyanurate. Furthermore, thermally unstable crosslinkers may include ester-based and amide-based crosslinkers that may be suitable in certain embodiments of the present disclosure include, but are not limited to, vinyl or allyl esters, such as diallyl carbonate, divinyl adipate, divinyl sebacate, N,N′-diallyltartardiamide, diallyl phthalate, diallyl maleate, and diallyl succinate. In some embodiments, the thermally unstable crosslinker can include at least one of triallyl isocyanurate and N, N-methylenebisacrylamide, particularly triallyl isocyanurate.

In some embodiments, the thermally unstable crosslinker is in an amount ranging from a lower limit of about 0.0001 mol % to about 20 mol %, about 0.001 mol % to about 20 mol %, about 0.01 mol % to about 20 mol %, about 0.1 mol % to about 20 mol %, about 0.15 mol % to about 20 mol %, about 0.2 mol % to about 20 mol %, about 0.25 mol % to about 20 mol %, about 0.3 mol % to about 20 mol %, about 0.35 mol % to about 20 mol %, about 0.4 mol % to about 20 mol %, about 0.45 mol % to about 20 mol %, about 0.5 mol % to about 20 mol %, about 0.55 mol % to about 20 mol %, about 0.6 mol % to about 20 mol %, about 0.65 mol % to about 20 mol %, about 0.7 mol % to about 20 mol %, about 0.75% to about 20 mol %, about 0.8% to about 20 mol %, about 0.85 mol % to about 20 mol %, about 0.9 mol % to about 20 mol %, about 0.95 mol % to about 20 mol %, about 0.0001 mol % to about 2 mol %, about 0.001 mol % to about 2 mol %, about 0.01 mol % to about 2 mol %, about 0.1 mol % to about 2 mol %, about 0.15 mol % to about 2 mol %, about 0.2 mol % to about 2 mol %, about 0.25 mol % to about 2 mol %, about 0.3 mol % to about 2 mol %, about 0.35 mol % to about 2 mol %, about 0.4 mol % to about 2 mol %, about 0.45 mol % to about 2 mol %, about 0.5 mol % to about 2 mol %, about 0.55 mol % to about 2 mol %, about 0.6 mol % to about 2 mol %, about 0.65 mol % to about 2 mol %, about 0.7 mol % to about 2 mol %, about 0.75% to about 2 mol %, about 0.8% to about 2 mol %, about 0.85 mol % to about 2 mol %, about 0.9 mol % to about 2 mol %, about 0.95 mol % to about 2 mol %, about 0.0001 mol % to about 1 mol %, about 0.001 mol % to about 1 mol %, about 0.01 mol % to about 1 mol %, about 0.1 mol % to about 1 mol %, about 0.15 mol % to about 1 mol %, about 0.2 mol % to about 1 mol %, about 0.25 mol % to about 1 mol %, about 0.3 mol % to about 1 mol %, about 0.35 mol % to about 1 mol %, about 0.4 mol % to about 1 mol %, about 0.45 mol % to about 1 mol %, about 0.5 mol % to about 1 mol %, about 0.55 mol % to about 1 mol %, about 0.6 mol % to about 1 mol %, about 0.65 mol % to about 1 mol %, about 0.7 mol % to about 1 mol %, about 0.75% to about 1 mol %, about 0.8% to about 1 mol %, about 0.85 mol % to about 1 mol %, about 0.9 mol % to about 1 mol %, about 0.95 mol % to about 1 mol %, about 1 mol % to about 2 mol %, about 2 mol % to about 3 mol %, about 3 mol % to about 4 mol %, about 4 mol % to about 5 mol %, about 5 mol % to about 10 mol %, about 10 mol % to about 15 mol %, or about 15 mol % to about 20 mol %, based on total moles of suspension reactants.

The thermally stable crosslinkers can include compounds with four or more functional groups, such as double bonds, including pentaerythritol, pentaerythritol tetra(meth)acrylate, pentaerythritol tetraallyl ether, allyl sucrose, tetraallylethylene diamine, tetraallylammonium chloride, tetraallyl orthosilicate, 1,3,5,7-tetravinyl-1,3,5,7-tetramethylcyclotetrasiloxane, or a combination thereof. In some embodiments, the compound with the at least four functional groups includes pentaerythritol tetraallyl ether. Furthermore, each of the at least four functional groups comprises, independently, a hydroxy or a propenyl. In some aspects, the thermally stable crosslinkers can be of the formula:

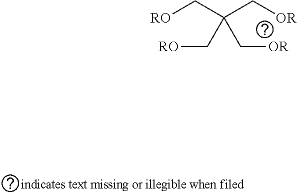

wherein R is

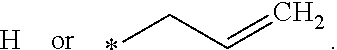

In some embodiments, the thermally stable crosslinker is in an amount ranging from a lower limit of about 0.0001 mol % to about 20 mol %, about 0.001 mol % to about 20 mol %, about 0.01 mol % to about 20 mol %, about 0.1 mol % to about 20 mol %, about 0.15 mol % to about 20 mol %, about 0.2 mol % to about 20 mol %, about 0.25 mol % to about 20 mol %, about 0.3 mol % to about 20 mol %, about 0.35 mol % to about 20 mol %, about 0.4 mol % to about 20 mol %, about 0.45 mol % to about 20 mol %, about 0.5 mol % to about 20 mol %, about 0.55 mol % to about 20 mol %, about 0.6 mol % to about 20 mol %, about 0.65 mol % to about 20 mol %, about 0.7 mol % to about 20 mol %, about 0.75% to about 20 mol %, about 0.8% to about 20 mol %, about 0.85 mol % to about 20 mol %, about 0.9 mol % to about 20 mol %, about 0.95 mol % to about 20 mol %, about 0.0001 mol % to about 2 mol %, about 0.001 mol % to about 2 mol %, about 0.01 mol % to about 2 mol %, about 0.1 mol % to about 2 mol %, about 0.15 mol % to about 2 mol %, about 0.2 mol % to about 2 mol %, about 0.25 mol % to about 2 mol %, about 0.3 mol % to about 2 mol %, about 0.35 mol % to about 2 mol %, about 0.4 mol % to about 2 mol %, about 0.45 mol % to about 2 mol %, about 0.5 mol % to about 2 mol %, about 0.55 mol % to about 2 mol %, about 0.6 mol % to about 2 mol %, about 0.65 mol % to about 2 mol %, about 0.7 mol % to about 2 mol %, about 0.75% to about 2 mol %, about 0.8% to about 2 mol %, about 0.85 mol % to about 2 mol %, about 0.9 mol % to about 2 mol %, about 0.95 mol % to about 2 mol %, about 0.0001 mol % to about 1 mol %, about 0.001 mol % to about 1 mol %, about 0.01 mol % to about 1 mol %, about 0.1 mol % to about 1 mol %, about 0.15 mol % to about 1 mol %, about 0.2 mol % to about 1 mol %, about 0.25 mol % to about 1 mol %, about 0.3 mol % to about 1 mol %, about 0.35 mol % to about 1 mol %, about 0.4 mol % to about 1 mol %, about 0.45 mol % to about 1 mol %, about 0.5 mol % to about 1 mol %, about 0.55 mol % to about 1 mol %, about 0.6 mol % to about 1 mol %, about 0.65 mol % to about 1 mol %, about 0.7 mol % to about 1 mol %, about 0.75% to about 1 mol %, about 0.8% to about 1 mol %, about 0.85 mol % to about 1 mol %, about 0.9 mol % to about 1 mol %, about 0.95 mol % to about 1 mol %, about 1 mol % to about 2 mol %, about 2 mol % to about 3 mol %, about 3 mol % to about 4 mol %, about 4 mol % to about 5 mol %, about 5 mol % to about 10 mol %, about 10 mol % to about 15 mol %, or about 15 mol % to about 20 mol %, based on total moles of suspension reactants.

In some aspects, the high temperature suspension additive can include the thermally stable crosslinker having the following chemical formula:

[A]-[B]_{y}
wherein A is a pentaerythritol moiety, a ethylenediamine moiety, a tetraallylammonium moiety, or a disaccharide moiety; B is, independently, a propenyl or an isobutenyl, optionally substituted by an oxo group; and y is an integer ranging from 4 to 16, or from 4 to 8. The disaccharide moiety can be a sucrose moiety, a lactose moiety, a maltose moiety, a trehalose moiety, a cellobiose moiety, a chitobiose moiety, or a combination thereof, or can be a sucrose moiety.

In some embodiments, the at least one monomer having a first monomer including an acrylamide and a second monomer including N-vinylpyrrolidone. In some aspects, the at least one monomer comprises a first monomer including an acrylamide and a second monomer comprising N-vinylpyrrolidone. Although these monomers may be used, other monomers can be utilized as described herein.

In some embodiments, the at least one monomer is from about 0.1 mole % to about 99.9 mole %, about 0.1 mole % to about 1 mole %, about 1 mole % to about 5 mole %, about 5 mole % to about 10 mole %, about 10 mole % to about 25 mole %, about 25 mole % to about 50 mole %, about 50 mole % to about 75 mole %, about 75 mole % to about 90 mole %, about 90 mole % to about 99 mole %, or about 99 mole % to about 99.9 mole % based on total moles of suspension reactants. In some embodiments, the at least one monomer comprises a first monomer comprising an acrylamide and a second monomer comprising N-vinylpyrrolidone can be in a mole ratio of about 0.1:about 99.9, about 1:about 99, about 5:about 95, about 10:about 90, about 20:about 80, about 25:about 75, about 30:about 70, about 40:about 60, or about 50:about 50, or about 99.9:about 0.1, about 99:about 1, about 95:about 5; about 90:about 10, about 80:about 20, about 75:about 25, about 70:about 30, or about 60:about 40, in a mole ratio of about 80:about 20, about 60:about 40, about 50:about 50, or about 40:about 60, or in a mole ratio of about 60:about 40.

In some embodiments, a wellbore treatment fluid can include a thermally stable additive or HTSA having a thermally stable crosslinker having a compound with at least four functional groups. More particularly, the thermally stable additive may be included in wellbore treatment fluids such as in spacer fluids and cement slurries where thermal thinning may occur. The wellbore treatment fluid can be placed downhole with a bottom hole static temperature (BHST) ranging from a lower limit of about 250° F. (121° C.), about 275° F. (135° C.), about 300° F. (149° C.), about 325° F. (163° C.), about 350° F. (177° C.), about 400° F. (204° C.), or about 450° F. (232° C.) to an upper limit of about 550° F. (288° C.), about 500° F. (260° C.), about 450° F. (232° C.), or about 400° F. (204° C.).

The wellbore treatment fluid can further include the fluid including an aqueous fluid, such as water, and the thermally unstable crosslinker and the thermally stable crosslinker comprise about 0.001 BWOW to about 10 BWOW, 0.01 BWOW to about 5 BWOW, 0.1 BWOW to about 4 BWOW, about 1 BWOW to about 3 BWOW, about 1 BWOW to about 2 BWOW, about 1.1 BWOW to about 2 BWOW, about 1.2 BWOW to about 2 BWOW, about 1.3 BWOW to about 2 BWOW, about 1.4 BWOW to about 2 BWOW, about 1.5 BWOW to about 2 BWOW, about 1.6 BWOW to about 2 BWOW, about 1.7 BWOW to about 2 BWOW, about 1.8 BWOW to about 2 BWOW, or about 1.9 BWOW to about 2 BWOW. The aqueous fluid can include fresh water, salt water, brine, a produced water, a surface water, or a combination thereof.

In some aspects, the wellbore treatment fluid further includes a cement selected from the group consisting of portland cement, slag cement, pozzolana cement, gypsum cement, aluminous cement, a silica cement, and combinations thereof, and optionally also includes a scouring material selected from the group consisting of pumice, perlite, volcanic glass, fumed silica, fly ash, and combinations thereof.

In some embodiments, a method for preparing a wellbore treatment fluid can include contacting a fluid with a high temperature suspension additive to form the wellbore treatment fluid. Generally, the high temperature suspension additive can be a reaction product of at least one monomer, a thermally unstable crosslinker, and a thermally stable crosslinker comprising a compound with at least four functional groups. Usually, the high temperature suspension additive maintains a viscosity of the wellbore treatment fluid at a high temperature for at least about 4 hours with a viscosity equal to or greater than about 25%, about 13%, or about 9.0% of a peak viscosity. In some other embodiments, a method for preparing a wellbore treatment fluid can include contacting a fluid with a high temperature suspension additive to form the wellbore treatment fluid. Generally, the high temperature suspension additive is prepared by (i) contacting at least one monomer and at least one crosslinker comprising a thermally unstable crosslinker and a thermally stable crosslinker comprising a compound with at least four functional groups with a two-phase solvent to form a mixture; and (ii) reacting the at least one monomer and the at least one crosslinker of the mixture in a reaction zone under conditions suitable to produce the high temperature suspension additive. The high temperature suspension additive can maintain a viscosity of the wellbore treatment fluid at a high temperature for at least about 4 hours with a viscosity no less than about 25%, about 13%, or about 9.0% of a peak viscosity.

In yet some other embodiments, a method for preparing a wellbore treatment fluid can include contacting a fluid with a high temperature suspension additive to form the wellbore treatment fluid. Generally, the high temperature suspension additive has a moiety with a chemical structure:

[A]ₓ-[C]_{y}

wherein:
A is a pentaerythritol moiety, a ethylenediamine moiety, a tetraallylammonium moiety, or a disaccharide moiety;
C is, independently, a propylene, an isobutylene, optionally substituted by an oxo group, or an ether linkage acting as a bond to an adjacent group;
x is an integer equal to or greater than 10; and
y is an integer ranging from 4 to 16, or 4 to 8.

Furthermore, any ingredients, amounts, and conditions as described herein may also be used to make the high temperature suspension additive and/or wellbore treatment fluid.

In some embodiments, a composition, can include at least one monomer and at least one crosslinker comprising a thermally unstable crosslinker and a thermally stable crosslinker in a two-phase solvent to form a suspension, wherein after activation of the crosslinker to achieve a peak viscosity after a yield point, a suspension maintains a viscosity no less than about 25%, about 13%, or about 9.0% less than the peak viscosity for at least about 2, or about 4 hours. In some aspects, the peak viscosity after the yield point occurs at a temperature of at least about 100° F. (38° C.), about 150° F. (66° C.), about 200° F. (93° C.), about 250° F. (121° C.), about 300° F. (149° C.), about 350° F. (177° C.), or about 390° F. (199° C.). The thermally unstable crosslinker can include at least one functional group and not more than three functional groups, and the thermally stable crosslinker can include a compound with at least four functional groups.

In certain embodiments, the thermally stable crosslinker is in an amount ranging from a lower limit of about 0.0001 mol % to about 20 mol %, about 0.001 mol % to about 20 mol %, about 0.01 mol % to about 20 mol %, about 0.1 mol % to about 20 mol %, about 0.15 mol % to about 20 mol %, about 0.2 mol % to about 20 mol %, about 0.25 mol % to about 20 mol %, about 0.3 mol % to about 20 mol %, about 0.35 mol % to about 20 mol %, about 0.4 mol % to about 20 mol %, about 0.45 mol % to about 20 mol %, about 0.5 mol % to about 20 mol %, about 0.55 mol % to about 20 mol %, about 0.6 mol % to about 20 mol %, about 0.65 mol % to about 20 mol %, about 0.7 mol % to about 20 mol %, about 0.75% to about 20 mol %, about 0.8% to about 20 mol %, about 0.85 mol % to about 20 mol %, about 0.9 mol % to about 20 mol %, about 0.95 mol % to about 20 mol %, about 0.0001 mol % to about 2 mol %, about 0.001 mol % to about 2 mol %, about 0.01 mol % to about 2 mol %, about 0.1 mol % to about 2 mol %, about 0.15 mol % to about 2 mol %, about 0.2 mol % to about 2 mol %, about 0.25 mol % to about 2 mol %, about 0.3 mol % to about 2 mol %, about 0.35 mol % to about 2 mol %, about 0.4 mol % to about 2 mol %, about 0.45 mol % to about 2 mol %, about 0.5 mol % to about 2 mol %, about 0.55 mol % to about 2 mol %, about 0.6 mol % to about 2 mol %, about 0.65 mol % to about 2 mol %, about 0.7 mol % to about 2 mol %, about 0.75% to about 2 mol %, about 0.8% to about 2 mol %, about 0.85 mol % to about 2 mol %, about 0.9 mol % to about 2 mol %, about 0.95 mol % to about 2 mol %, about 0.0001 mol % to about 1 mol %, about 0.001 mol % to about 1 mol %, about 0.01 mol % to about 1 mol %, about 0.1 mol % to about 1 mol %, about 0.15 mol % to about 1 mol %, about 0.2 mol % to about 1 mol %, about 0.25 mol % to about 1 mol %, about 0.3 mol % to about 1 mol %, about 0.35 mol % to about 1 mol %, about 0.4 mol % to about 1 mol %, about 0.45 mol % to about 1 mol %, about 0.5 mol % to about 1 mol %, about 0.55 mol % to about 1 mol %, about 0.6 mol % to about 1 mol %, about 0.65 mol % to about 1 mol %, about 0.7 mol % to about 1 mol %, about 0.75% to about 1 mol %, about 0.8% to about 1 mol %, about 0.85 mol % to about 1 mol %, about 0.9 mol % to about 1 mol %, about 0.95 mol % to about 1 mol %, about 1 mol % to about 2 mol %, about 2 mol % to about 3 mol %, about 3 mol % to about 4 mol %, about 4 mol % to about 5 mol %, about 5 mol % to about 10 mol %, about 10 mol % to about 15 mol %, or about 15 mol % to about 20 mol %, based on total moles of suspension reactants.

In some aspects, the thermally unstable crosslinker is in an amount ranging from a lower limit of about 0.0001 mol % to about 20 mol %, about 0.001 mol % to about 20 mol %, about 0.01 mol % to about 20 mol %, about 0.1 mol % to about 20 mol %, about 0.15 mol % to about 20 mol %, about 0.2 mol % to about 20 mol %, about 0.25 mol % to about 20 mol %, about 0.3 mol % to about 20 mol %, about 0.35 mol % to about 20 mol %, about 0.4 mol % to about 20 mol %, about 0.45 mol % to about 20 mol %, about 0.5 mol % to about 20 mol %, about 0.55 mol % to about 20 mol %, about 0.6 mol % to about 20 mol %, about 0.65 mol % to about 20 mol %, about 0.7 mol % to about 20 mol %, about 0.75% to about 20 mol %, about 0.8% to about 20 mol %, about 0.85 mol % to about 20 mol %, about 0.9 mol % to about 20 mol %, about 0.95 mol % to about 20 mol %, about 0.0001 mol % to about 2 mol %, about 0.001 mol % to about 2 mol %, about 0.01 mol % to about 2 mol %, about 0.1 mol % to about 2 mol %, about 0.15 mol % to about 2 mol %, about 0.2 mol % to about 2 mol %, about 0.25 mol % to about 2 mol %, about 0.3 mol % to about 2 mol %, about 0.35 mol % to about 2 mol %, about 0.4 mol % to about 2 mol %, about 0.45 mol % to about 2 mol %, about 0.5 mol % to about 2 mol %, about 0.55 mol % to about 2 mol %, about 0.6 mol % to about 2 mol %, about 0.65 mol % to about 2 mol %, about 0.7 mol % to about 2 mol %, about 0.75% to about 2 mol %, about 0.8% to about 2 mol %, about 0.85 mol % to about 2 mol %, about 0.9 mol % to about 2 mol %, about 0.95 mol % to about 2 mol %, about 0.0001 mol % to about 1 mol %, about 0.001 mol % to about 1 mol %, about 0.01 mol % to about 1 mol %, about 0.1 mol % to about 1 mol %, about 0.15 mol % to about 1 mol %, about 0.2 mol % to about 1 mol %, about 0.25 mol % to about 1 mol %, about 0.3 mol % to about 1 mol %, about 0.35 mol % to about 1 mol %, about 0.4 mol % to about 1 mol %, about 0.45 mol % to about 1 mol %, about 0.5 mol % to about 1 mol %, about 0.55 mol % to about 1 mol %, about 0.6 mol % to about 1 mol %, about 0.65 mol % to about 1 mol %, about 0.7 mol % to about 1 mol %, about 0.75% to about 1 mol %, about 0.8% to about 1 mol %, about 0.85 mol % to about 1 mol %, about 0.9 mol % to about 1 mol %, about 0.95 mol % to about 1 mol %, about 1 mol % to about 2 mol %, about 2 mol % to about 3 mol %, about 3 mol % to about 4 mol %, about 4 mol % to about 5 mol %, about 5 mol % to about 10 mol %, about 10 mol % to about 15 mol %, or about 15 mol % to about 20 mol %, based on total moles of suspension reactants.

In some embodiments, the at least one monomer is from about 0.1 mole % to about 99.9 mole %, about 0.1 mole % to about 1 mole %, about 1 mole % to about 5 mole %, about 5 mole % to about 10 mole %, about 10 mole % to about 25 mole %, about 25 mole % to about 50 mole %, about 50 mole % to about 75 mole %, about 75 mole % to about 90 mole %, about 90 mole % to about 99 mole %, or about 99 mole % to about 99.9 mole % based on total moles of suspension reactants. Generally, the at least one monomer includes a first monomer comprising an acrylamide and a second monomer comprising N-vinylpyrrolidone, although other monomers may be used as described herein.

In certain embodiments, the at least one monomer comprises a first monomer comprising an acrylamide and a second monomer comprising N-vinylpyrrolidone, and the acrylamide and N-vinylpyrrolidone are in a mole ratio of about 0.1:about 99.9, about 1:about 99, about 5:about 95, about 10:about 90, about 20:about 80, about 25:about 75, about 30:about 70, about 40:about 60, or about 50:about 50, or about 99.9:about 0.1, about 99:about 1, about 95:about 5; about 90:about 10, about 80:about 20, about 75:about 25, about 70:about 30, or about 60:about 40, are in a mole ratio of about 80:about 20, about 60:about 40, about 50:about 50, or about 40:about 60, or even in a mole ratio of about 60:about 40. In some aspects, the two-phase solvent comprises an alkanol and water, although other solvents may be used as described herein.

In some embodiments, a wellbore treatment fluid can include a fluid, and a high temperature suspension additive comprising a polymer product of a monomer, a thermally unstable crosslinker and a thermally stable crosslinker, which has a property of maintaining viscosity of the wellbore treatment fluid at a high temperature for at least about 4 hours with a viscosity no less than about 25%, about 13% less than a peak viscosity.

In some aspects, a wellbore treatment fluid can include a fluid, and a high temperature suspension additive having a moiety with a chemical structure:

[A]ₓ-[C]_{y}

wherein:
A is a pentaerythritol moiety, a ethylenediamine moiety, a tetraallylammonium moiety, or a disaccharide moiety;
C is, independently, a propylene, an isobutylene, optionally substituted by an oxo group, or an ether linkage acting as a bond to an adjacent group;
x is an integer equal to or greater than 10; and
y is an integer ranging from 4 to 16, or 4 to 8.

In some embodiments, a composition, can include at least one monomer and at least one crosslinker comprising a thermally unstable crosslinker and a thermally stable crosslinker in a two-phase solvent to form a suspension, wherein the thermally stable crosslinker comprises a compound with at least four functional groups. Generally, the compound with at least four functional groups includes pentaerythritol tetra(meth)acrylate, pentaerythritol tetraallyl ether, allyl sucrose, tetraallylethylene diamine, tetraallylammonium chloride, tetraallyl orthosilicate, 1,3,5,7-tetravinyl-1,3,5,7-tetramethylcyclotetrasiloxane, or a combination thereof. Sometimes, the compound with at least four functional groups includes pentaerythritol tetraallyl ether. The thermally unstable crosslinker can include at least one functional group and not more than three functional groups. In some embodiments, the thermally unstable crosslinker includes at least one of triallyl isocyanurate and N, N-methylenebisacrylamide. Generally, the thermally unstable crosslinker includes triallyl isocyanurate.

In some embodiments, at least one crosslinker comprises about 0.001 BWOW to about 10 BWOW, 0.01 BWOW to about 5 BWOW, 0.1 BWOW to about 4 BWOW, about 1 BWOW to about 3 BWOW, about 1 BWOW to about 2 BWOW, about 1.1 BWOW to about 2 BWOW, about 1.2 BWOW to about 2 BWOW, about 1.3 BWOW to about 2 BWOW, about 1.4 BWOW to about 2 BWOW, about 1.5 BWOW to about 2 BWOW, about 1.6 BWOW to about 2 BWOW, about 1.7 BWOW to about 2 BWOW, about 1.8 BWOW to about 2 BWOW, or about 1.9 BWOW to about 2 BWOW of the wellbore treatment fluid.

A method can include preparing a high temperature suspension additive, including contacting an acrylamide, N-vinylpyrrolidone, triallyl isocyanurate, and pentaerythritol tetraallyl ether in a two-phase solvent to form a suspension; and reacting the acrylamide and the N-vinylpyyrolidone to produce the high temperature suspension additive. Generally, the high temperature suspension additive maintains viscosity of a wellbore treatment fluid at a high temperature for at least about 4 hours with a viscosity no less than about 25%, about 13%, or about 9.0% of a peak viscosity.

In some embodiments, a method can include contacting a fluid with a high temperature suspension additive to form a treatment fluid and placing the treatment fluid downhole. Generally, the high temperature suspension additive is a reaction product of at least one monomer, a thermally unstable crosslinker, and a thermally stable crosslinker comprising a compound with at least four functional groups, wherein at least some of the four functional groups provide cross-linking of the monomer in a polymer chain.

In some aspects, the method can further include displacing a fluid downhole during the placing of the treatment fluid. The treatment fluid can be placed downhole into a wellbore and/or a subterranean formation. Generally, the high temperature suspension additive is operable at a temperature of about 275° F. (135° C.) to about 550° F. (288° C.), and the treatment fluid is a spacer fluid. Sometimes, the treatment fluid further can include a cement selected from the group consisting of a portland cement, a slag cement, a pozzolana cement, a gypsum cement, an aluminous cement, a silica cement; and combinations thereof, and the treatment fluid can further include a material selected from the group consisting of a pumice, a perlite, a volcanic glass, a fumed silica, a fly ash, and combinations thereof.

In certain other embodiments, a method can include contacting high temperature suspension additive, water, and a cement blend to form a wellbore servicing fluid at a location proximate a wellsite, placing the wellbore servicing fluid in a wellbore penetrating a subterranean formation, and allowing the wellbore servicing fluid to set. Generally, the high temperature suspension additive can include a polymer product of an acrylamide, N-vinylpyrrolidone, triallyl isocyanurate, and pentaerythritol tetraallyl ether in a two-phase solvent to form a suspension which has a property of maintaining viscosity of a wellbore treatment fluid at a high temperature for at least about 4 hours with a viscosity no less than about 25%, about 13%, or about 9.0% of a peak viscosity. The method can further include displacing a fluid downhole during the placing of the treatment fluid. Generally, the treatment fluid can be placed downhole into a wellbore and/or a subterranean formation. In some aspects, the high temperature suspension additive is operable at a temperature of about 275° F. (135° C.) to about 550° F. (288° C.). Sometimes, the treatment fluid is a spacer fluid. The treatment fluid can further include a cement selected from the group consisting of a portland cement, a slag cement, a pozzolana cement, a gypsum cement, an aluminous cement, a silica cement, and combinations thereof, and the treatment fluid can further include a material selected from the group consisting of a pumice, a perlite, a volcanic glass, a fumed silica, a fly ash, and combinations thereof.

In some embodiments, a method can include preparing a wellbore treatment fluid including water, and a thermally stable additive including a polymer product of acrylamide, N-vinylpyyrolidone, at least one thermally unstable crosslinker comprising N, N-methylenebisacrylamide, and at least one thermally stable crosslinker comprising triallyl isocyanurate polymerized in a binary solvent system, and displacing a fluid disposed in a wellbore using the wellbore treatment fluid. The at least one thermally unstable crosslinker can have a property of hydrolyzing at a temperature above about 250° F. (121° C.) in the wellbore treatment fluid, and the at least one thermally stable crosslinker which may have a property of remaining hydrolytically stable at a temperature in a range of about 250° F. (121° C.) to about 450° F. (232° C.) in the wellbore treatment fluid for a period of at least about 1 hour. Generally, the binary solvent system can include about 3 to about 5 volume percent water and about 95 volume percent to about 97 volume percent t-butanol based on a total volume of the binary solvent system, or about 4 to about 6 volume percent water and about 94 volume percent to about 96 volume percent n-butanol based on a total volume of the binary solvent system. In some embodiments, the wellbore treatment fluid may further include a cement selected from the group consisting of portland cement, slag cement, pozzolana cement, gypsum cement, aluminous cement, a silica cement, and combinations thereof, and may still further include a material selected from the group consisting of pumice, perlite, volcanic glass, fumed silica, fly ash, and combinations thereof.

In some embodiments, a cement slurry may include the thermally stable additive, a cement, and water. The thermally stable additive may be used with any wellbore cement including hydraulic cements such as a Portland cement including API classes A, B, C, G, and H; a slag cement; a pozzolana cement; a gypsum cement; an aluminous cement; a silica cement; a high alkalinity cement; and any combination thereof. Suitable water may include fresh water, saltwater (e.g., water containing one or more salts dissolved therein), brine (e.g., saturated salt water), seawater, and any combination thereof. Generally, the water may be from any source, provided that it does not contain components that might adversely affect the stability and/or performance of the compositions or methods of the present disclosure. The cement slurry may include the thermally stable additive in any amount including from about 0.1% by weight of cement (bwoc) to about 5% bwoc. Alternatively, from about 0.1% bwoc to about 0.5% bwoc, about 0.5% bwoc to about 1% bwoc, about 1% bwoc to about 2% bwoc, about 2% bwoc to about 3% bwoc, about 3% bwoc to about 5% bwoc, or any ranges therebetween.

The cement slurry may further include any suitable additive such as any suitable particulate. A suitable particulate for use in the present invention may be any particulate suitable for use in a subterranean formation including, but not limited to, cementitious particulates, weighting agents, proppants, fine aggregate particulates, and any combination thereof. Suitable particulates for use in the present invention may have a diameter ranging from a lower limit of about 0.5 μm, about 1 μm, about 10 μm, about 50 μm, about 0.1 mm, or about 1 mm to an upper limit of about 10 mm, about 1 mm, about 0.5 mm, about 0.1 mm, or about 50 μm, and wherein the diameter may range from any lower limit to any upper limit and encompass any subset between the upper and lower limits. A particulate may be present in a treatment fluid in an amount ranging from a lower limit of about 1%, about 5%, about 10%, about 20%, about 30%, about 40%, or about 50% by weight of treatment fluid to an upper limit of about 99%, about 90%, about 80%, about 70%, about 60%, about 50%, or about 40% by weight of treatment fluid, and wherein the amount may range from any lower limit to any upper limit and encompass any subset between the upper and lower limits.

Suitable weighting agents for use in the present disclosure may be any known weighting agent that is a particulate including, but not limited to, barite, iron oxide, iron carbonate hematite; manganese tetraoxide; galena; silica; siderite; celestite; ilmenite; dolomite; calcium carbonate; and any combination thereof. Suitable proppants for use in the present disclosure may be any known proppant including, but not limited to, sand, bauxite, ceramic materials, glass materials, polymer materials, polytetrafluoroethylene materials, nut shell pieces, cured resinous particulates comprising nut shell pieces, seed shell pieces, cured resinous particulates comprising seed shell pieces, fruit pit pieces, cured resinous particulates comprising fruit pit pieces, wood, composite particulates, and any combination thereof. Suitable composite particulates may comprise a binder and a filler material wherein suitable filler materials include silica, alumina, fumed carbon, carbon black, graphite, mica, titanium dioxide, meta-silicate, calcium silicate, kaolin, talc, zirconia, boron, fly ash, hollow glass microspheres, solid glass, and any combination thereof.

Suitable fine aggregate particulates for use in the present disclosure may include, but are not limited to, fly ash, silica flour, fine sand, diatomaceous earth, lightweight aggregates, hollow spheres, and any combination thereof.

In some examples, the cement slurry may further include a lightweight additive. The lightweight additive may be included to reduce the density of examples of the cement slurry. For example, the lightweight additive may be used to form a lightweight cement slurry, for example, having a density of less than about 13 ppg. The lightweight additive typically may have a specific gravity of less than about 2.0. Examples of suitable lightweight additives may include sodium silicate, hollow microspheres, gilsonite, perlite, and combinations thereof. Where used, the lightweight additive may be present in an amount in the range of from about 0.1% to about 20% by weight of dry solids, for example. In alternative examples, the lightweight additive may be present in an amount in the range of from about 1% to about 10% by weight of dry solids.

The cement slurry generally should have a density suitable for a particular application. In some embodiments, the cement slurry may have a density in the range of from about 4 pounds per gallon (“lb/gal”) (480 kg/m3) to about 24 lb/gal (2900 kg/m3). In other embodiments, the cement slurry may have a density in the range of about 4 lb/gal (480 kg/m3) to about 17 lb/gal (2040 kg/m3). In yet other embodiments, the cement slurry may have a density in the range of about 8 lb/gal (960 kg/m3) to about 13 lb/gal (1600 kg/m3), about 13 lb/gal (1600 kg/m3) to about 20 lb/gal (2396 kg/m3). In some examples, the cement slurry may be foamed and include water, thermally stable additive, a foaming agent, and a gas. Optionally, to provide a cement slurry with a lower density and more stable foam, the foamed cement slurry may further comprise a lightweight additive, for example. With the lightweight additive, a base slurry may be prepared that may then be foamed to provide an even lower density. In some embodiments, the foamed spacer fluid may have a density in the range of from about 4 ppg (479 kg/m3) to about 13 ppg (1558 kg/m3) and, alternatively, about 7 ppg (839 kg/m3) to about 9 ppg (839 kg/m3). In one particular example, a base slurry may be foamed from a density of in the range of from about 9 ppg (839 kg/m3) to about 13 ppg (1558 kg/m3) to a lower density, for example, in a range of from about 7 ppg (839 kg/m3) to about 9 ppg (839 kg/m3).

The gas used in embodiments of the foamed cement slurry may be any suitable gas for foaming the cement slurry, including, but not limited to air, nitrogen, and combinations thereof. Generally, the gas should be present in examples of the foamed cement slurries in an amount sufficient to form the desired foam. In certain embodiments, the gas may be present in an amount in the range of from about 5% to about 80% by volume of the foamed spacer fluid at atmospheric pressure, alternatively, about 5% to about 55% by volume, and, alternatively, about 15% to about 30% by volume.

Where foamed, examples of the cement slurries may comprise a foaming agent for providing a suitable foam. As used herein, the term “foaming agent” refers to a material or combination of materials that facilitate the formation of a foam in a liquid. Any suitable foaming agent for forming a foam in an aqueous liquid may be used in embodiments of the cement slurries. Examples of suitable foaming agents may include, but are not limited to: anionic, nonionic, amphoteric (including zwitterionic surfactants), cationic surfactant, or mixtures thereof, betaines; anionic surfactants such as hydrolyzed keratin; amine oxides such as alkyl or alkene dimethyl amine oxides; cocoamidopropyl dimethylamine oxide; methyl ester sulfonates; alkyl or alkene amidobetaines such as cocoamidopropyl betaine; alpha-olefin sulfonates; quaternary surfactants such as trimethyltallowammonium chloride and trimethylcocoammonium chloride; C₈ to C₂₂ alkylethoxylate sulfates; and combinations thereof. Specific examples of suitable foaming additives include, but are not limited to: mixtures of an ammonium salt of an alkyl ether sulfate, a cocoamidopropyl betaine surfactant, a cocoamidopropyl dimethylamine oxide surfactant, sodium chloride, and water; mixtures of an ammonium salt of an alkyl ether sulfate surfactant, a cocoamidopropyl hydroxysultaine surfactant, a cocoamidopropyl dimethylamine oxide surfactant, sodium chloride, and water; hydrolyzed keratin; mixtures of an ethoxylated alcohol ether sulfate surfactant, an alkyl or alkene amidopropyl betaine surfactant, and an alkyl or alkene dimethylamine oxide surfactant; aqueous solutions of an alpha-olefinic sulfonate surfactant and a betaine surfactant, mixtures of an ammonium salt of an alkyl ether sulfate, and combinations thereof. Generally, the foaming agent may be present in embodiments of the foamed cement slurries in an amount sufficient to provide a suitable foam. In some embodiments, the foaming agent may be present in an amount in the range of from about 0.8% to about 5% by volume of the water (“bvow”).

The cement slurry may include a natural pozzolan such as fly ash, silica fume, metakaolin, or combinations thereof. An example of a suitable pozzolan may include fly ash. A variety of fly ash may be suitable, including fly ash classified as Class C and Class F fly ash according to American Petroleum Institute, API Specification for Materials and Testing for Well Cements, API Specification 10, Fifth Ed., Jul. 1, 1990. Class C fly ash includes both silica and lime, so it may set to form a hardened mass upon mixing with water. Class F fly ash generally does not contain a sufficient amount of lime to induce a cementitious reaction, therefore, an additional source of calcium ions is necessary for consolidation embodiments of a cement slurry including Class F fly ash. In some examples, lime may be mixed with Class F fly ash in an amount in the range of about 0.1% to about 100% by weight of the fly ash. In some instances, the lime may be hydrated lime. An example of a suitable pozzolan may include metakaolin. Generally, metakaolin is a white pozzolan that may be prepared by heating kaolin clay to temperatures in the range of about 600° C. to about 800° C. Where used, the metakaolin may be present in an amount in the range of from about 0.1% to about 40% by weight of the cement slurry. For example, the metakaolin may be present in an amount ranging between any of and/or including any of about 0.1%, about 10%, about 20%, about 30%, or about 40% by weight of the cement slurry. An additional example of a suitable pozzolan may include a natural pozzolan. Natural pozzolans are generally present on the Earth's surface and set and harden in the presence of hydrated lime and water. Examples including natural pozzolans may include natural glasses, diatomaceous earth, volcanic ash, opaline shale, tuff, and combinations thereof. The natural pozzolans may be ground or unground.

The cement slurry may further include hydrated lime. As used herein, the term “hydrated lime” will be understood to mean calcium hydroxide. In some examples, the hydrated lime may be provided as quicklime (calcium oxide) which hydrates when mixed with water to form the hydrated lime. The hydrated lime may be included in examples of the consolidating embodiments of the spacer fluid, for example, to form a hydraulic composition with the thermally stable additive. For example, the hydrated lime may be included in a pozzolan to-hydrated-lime weight ratio of about 10:1 to about 1:1 or a ratio of about 3:1 to about 5:1. Where present, the hydrated lime may be included in the cement slurries in an amount at a point in a range of from about 1% to about 40% by weight of the cement slurry, for example. In some examples, the hydrated lime may be present in an amount ranging between any of and/or including any of about 1%, about 10%, about 20%, about 30%, or about 40% by weight of the cement slurry.

Some examples of the cement slurry may include silica sources in addition to the thermally stable additive; for example, crystalline silica and/or amorphous silica. Amorphous silica is a powder that may be included in examples of the cement slurry as a lightweight filler. Amorphous silica is generally a byproduct of a ferrosilicon production process, wherein the amorphous silica may be formed by oxidation and condensation of gaseous silicon suboxide, SiO, which is formed as an intermediate during the process. Examples including additional silica sources may utilize the additional silica source as needed to enhance compressive strength or set times in consolidating embodiments of the cementing slurries.

In some embodiments, a thermally stable additive may be included in a first fluid that is placed in a wellbore and/or subterranean formation before and/or after a second fluid, wherein the second fluid comprises a plurality of particulates and the thermally stable additive. In some embodiments, the concentration of thermally stable additive may be different in a first fluid than in a second fluid. In some embodiments, the first fluid may be a spacer fluid and the second fluid may be a treatment fluid.

In consolidating examples of the cement slurry, the cement slurry may consolidate to form a mass that resists deformation. Consolidating examples of the cement slurry may include water, thermally stable additive, and a source of calcium and hydroxide ions such as lime, for example. In general, pozzolans are able to participate in the pozzolanic reaction through reaction of the silaceous and/or aluminous components of the pozzolan with calcium ions and hydroxide ions in water. The pozzolanic reaction may cause the cement slurry to form compressive strength. Compressive strength is generally the capacity of a material or structure to withstand axially directed pushing forces. The compressive strength may be measured according to techniques set forth in API RP-10B-2, Recommended Practice for Testing Well Cements, 2nd Edition published April 2013. Compressive strength is generally measured at a specified time after the cement slurry has been prepared and the resultant composition is maintained under specified temperature and pressure conditions. Compressive strength can be measured by either destructive or non-destructive methods. The destructive method physically tests the strength of consolidated cement slurry at various points in time by crushing the samples in a compression-testing machine. The compressive strength is calculated from the failure load divided by the cross-sectional area resisting the load and is reported in units of pound-force per square inch (psi). Non-destructive methods may employ a USA™ ultrasonic cement analyzer, available from Fann® Instrument Company, Houston, TX. Compressive strength values may be determined in accordance with API RP-10B-2, Recommended Practice for Testing Well Cements, 2nd Edition published April 2013.

By way of example, consolidating embodiments of the cement slurry may develop a 24-hour compressive strength in the range of from about 10 psi to about 2,000 psi, alternatively, from about 10 psi to about 100 psi, alternatively from about 100 psi to about 1,000 psi, alternatively from about 1,000 psi to about 1,500 psi, or alternatively from about 1,500 psi to about 2,000 psi. In some examples, the compressive strength values may be determined using destructive or non-destructive methods at a temperature ranging from about 100° F. (38° C.) to about 200° F. (93° C.).

The cement slurry may further include kiln dust. “Kiln dust,” as that term is used herein, refers to a solid material generated as a by-product of the heating of certain materials in kilns. The term “kiln dust” as used herein is intended to include kiln dust made as described herein and equivalent forms of kiln dust. Depending on its source, kiln dust may exhibit cementitious properties in that it can set and harden in the presence of water. Examples of suitable kiln dusts include cement kiln dust, lime kiln dust, and combinations thereof. Cement kiln dust may be generated as a by-product of cement production that is removed from the gas stream and collected, for example, in a dust collector. Usually, large quantities of cement kiln dust are collected in the production of cement that are commonly disposed of as waste. The chemical analysis of the cement kiln dust from various cement manufactures varies depending on a number of factors, including the particular kiln feed, the efficiency of the cement production operation, and the associated dust collection systems. Cement kiln dust generally may include a variety of oxides, such as SiO₂, Al₂O₃, Fe₂O₃, CaO, MgO, SO₃, Na₂O, and K₂O. Problems may also be associated with the disposal of lime kiln dust, which may be generated as a by-product of the calcination of lime. The chemical analysis of lime kiln dust from various lime manufacturers varies depending on several factors, including the particular limestone or dolomitic limestone feed, the type of kiln, the mode of operation of the kiln, the efficiencies of the lime production operation, and the associated dust collection systems. Lime kiln dust generally may include varying amounts of free lime and free magnesium, limestone, and/or dolomitic limestone and a variety of oxides, such as SiO₂, Al₂O₃, Fe₂O₃, CaO, MgO, SO₃, Na₂O, and K₂O, and other components, such as chlorides.

The cement slurries may further include barite. In some examples, the barite may be present in the cement slurries in an amount in the range of from about 1% to about 60% by weight of the cement slurries (e.g., about 5%, about 10%, about 15%, about 20%, about 25%, about 30%, about 35%, about 40%, about 45%, about 50%, about 55%, etc.). In some examples, the barite may be present in the cement slurries in an amount in the range of from about 1% to about 35% by weight of the cement slurries. In some examples, the barite may be present in the cement slurries in an amount in the range of from about 1% to about 10% by weight of the cement slurries. Alternatively, the amount of barite may be expressed by weight of dry solids. For example, the barite may be present in an amount in a range of from about 1% to about 99% by weight of dry solids (e.g., about 1%, about 5%, about 10%, about 20%, about 30%, about 40%, about 50%, about 60%, about 70%, about 80%, about 90%, about 99%, etc.). In some examples, the barite may be present in an amount in the range of from about 1% to about 20% and, alternatively, from about 1% to about 10% by weight of dry solids.

In some embodiments, the cement slurry may further include one or more of slag, perlite, shale, amorphous silica, or metakaolin. These additives may be included in the cement slurries to improve one or more properties of the cement slurry. The cement slurries may further include slag. Slag is generally a granulated, blast furnace by-product from the production of cast iron including the oxidized impurities found in iron ore. Where used, the slag may be present in an amount in the range of from about 0.1% to about 40% by weight of the cement slurry. The cement slurry may further include perlite. Perlite is an ore and generally refers to a naturally occurring volcanic, amorphous siliceous rock including mostly silicon dioxide and aluminum oxide. Perlite may be expanded and/or unexpanded as suitable for a particular application. The expanded or unexpanded perlite may also be ground, for example. Where used, perlite may be present in an amount in the range of from about 0.1% to about 40% by weight of the cement slurry. For example, perlite may be present in an amount ranging between any of and/or including any of about 0.1%, about 10%, about 20%, about 30%, or about 40% by weight of the cement slurry. The cement slurry may further include shale. A variety of shales are suitable, including those including silicon, aluminum, calcium, and/or magnesium. Examples of suitable shales include vitrified shale and/or calcined shale. Where used, the shale may be present in an amount in the range of from about 0.1% to about 40% by weight of the cement slurry. For example, the shale may be present in an amount ranging between any of and/or including any of about 0.1%, about 10%, about 20%, about 30%, or about 40% by weight of the cement slurry.

The cement slurry may further include a free water control additive. As used herein, the term “free water control additive” refers to an additive included in a liquid for, among other things, reducing or preventing the presence of free water in the liquid. Free water control additive may also reduce or prevent the settling of solids. Examples of suitable free water control additives include, but are not limited to, bentonite, amorphous silica, hydroxyethyl cellulose, and combinations thereof. The free water control additive may be provided as a dry solid in some embodiments. Where used, the free water control additive may be present in an amount in the range of from about 0.1% to about 16% by weight of dry solids, for example. In alternative embodiments, the free water control additive may be present in an amount in the range of from about 0.1% to about 2% by weight of dry solids.

Optionally, fluid-loss-control additives may be included in the cement slurry, for example, decrease the volume of fluid that is lost to the subterranean formation. Examples of suitable fluid-loss-control additives include, but not limited to, certain polymers, such as hydroxyethyl cellulose, carboxymethylhydroxyethyl cellulose, copolymers of 2-acrylamido-2-methylpropanesulfonic acid and acrylamide or N,N-dimethylacrylamide, and graft copolymers including a backbone of lignin or lignite and pendant groups including at least one member selected from the group consisting of 2-acrylamido-2-methylpropanesulfonic acid, acrylonitrile, and N,N-dimethylacrylamide.

Optionally, lost-circulation materials may be included in the cement slurries to, for example, help prevent the loss of fluid circulation into the subterranean formation. Examples of lost-circulation materials include but are not limited to, cedar bark, shredded cane stalks, mineral fiber, mica flakes, cellophane, calcium carbonate, ground rubber, polymeric materials, pieces of plastic, grounded marble, wood, nut hulls, formica, corncobs, cotton hulls, and combinations thereof.

Optionally, set accelerators may be included in consolidating examples of cement slurries, for example, to increase the rate of setting reactions. Control of setting time may allow for the ability to adjust to wellbore conditions or customize set times for individual jobs. Examples of suitable set accelerators may include, but are not limited to, aluminum sulfate, alums, calcium chloride, calcium sulfate, gypsum-hemihydrate, sodium aluminate, sodium carbonate, sodium chloride, sodium silicate, sodium sulfate, ferric chloride, or a combination thereof.

Optionally, set retarders may be included in consolidating examples of cement slurries to, for example, increase the thickening time of the cement slurries. Examples of suitable set retarders include, but are not limited to, ammonium, alkali metals, alkaline earth metals, borax, metal salts of calcium lignosulfonate, carboxymethyl hydroxyethyl cellulose, sulfoalkylated lignins, hydroxycarboxy acids, 5-chloro-2-methyl-3 (2H)-isothiazolone mixture with 2-methyl-3 (2H)-isothiazolone, copolymers of 2-acrylamido-2-methylpropane sulfonic acid salt and acrylic acid or maleic acid, saturated salt, or a combination thereof. One example of a suitable sulfoalkylated lignin includes a sulfomethylated lignin.

As previously mentioned, the cement slurries may consolidate after placement in the wellbore. By way of example, the cement slurries may develop gel and/or compressive strength when left in the wellbore. As a specific example of consolidation, when left in a wellbore annulus (e.g., between a subterranean formation and the pipe string disposed in the subterranean formation or between the pipe string and a larger conduit disposed in the subterranean formation), the cement slurry may consolidate to develop static gel strength and/or compressive strength. The consolidated mass formed in the wellbore annulus may act to support and position the pipe string in the wellbore and bond the exterior surface of the pipe string to the walls of the wellbore or to the larger conduit. The consolidated mass formed in the wellbore annulus may also provide a substantially impermeable barrier to seal off formation fluids and gases and consequently also serve to mitigate potential fluid migration. The consolidated mass formed in the wellbore annulus may also protect the pipe string or other conduit from corrosion.

The cement slurries may be prepared in accordance with any suitable technique. In some examples, the desired quantity of water may be introduced into a mixer (e.g., a cement blender) followed by a dry blend of the spacer fluid components. The dry blend may comprise the thermally stable additive and additional solid additives such as those described herein. Additional liquid additives, if any, may be added to the water as desired prior to, or after, combination with the dry blend. This mixture may be agitated for a sufficient period of time to form a pumpable slurry. By way of example, pumps may be used for delivery of this pumpable slurry into the wellbore.

In some embodiments, a thermally stable additive may be provided in wet or dry form. In some embodiments, a thermally stable additive may be added to a treatment fluid on-site or off-site of the wellbore location.

The components of the cement composition may be combined in any order desired to form a cement composition that can be placed into a subterranean formation. In addition, the components of the cement compositions may be combined using any mixing device compatible with the composition, including a bulk mixer, for example. In one particular example, a cement composition may be prepared by dry blending the solid components of the cement composition at a bulk plant, for example, and thereafter combining the dry blend with water when desired for use. For example, a dry blend may be prepared that includes the thermally stable additive and the other dry cement components. Liquid additives (if any) may be combined with the water before the water is combined with the dry components or added directly to a mixer tub. In some examples, a jet mixer may be used, for example, to continuously mix the dry blend including the cement composition, for example, with the water as it is being pumped to the wellbore.

In some examples, the thermally stable additive may be included in a spacer fluid. Spacers, also sometimes referred to as displacement fluids, wash fluids, or inverter fluids, are placed in the wellbore after drilling and before cementing. Spacers prepare the wellbore to receive cement. For instance, a spacer may fully displace drilling fluid from the wellbore annulus and/or condition the casing and wellbore surface to bond with cement. Drilling fluid can contaminate the cement, which can eventually lead to issues such as incompatibility, poor bonding as well as suppression of compressive strength development. The presence of drilling fluid filter cake over the casing may affect the bonding between the casing and cement and lead to formation of micro channels. Accordingly, spacers often remove any cakes from the drilling fluid and leave the casing and annulus water-wet to receive cement. A spacer fluid may include water and the thermally stable additive. Spacer fluids may be formulated by mixing a spacer dry blend comprising the thermally stable additive and water. The spacer dry blend may include the thermally stable additive along with any other dry components for a particular application. In examples a spacer fluid may include the thermally stable additive in any amount including from about 0.01% by bwob (by weight of spacer dry blend) to about 50% bwob. Alternatively, from about 0.01% bwob to about 0.05% bwob, about 0.05% bwob to about 0.1% bwob, about 0.1% bwob to about 0.5% bwob, about 0.5% bwob to about 1% bwob, about 1% bwob to about 2% bwob, about 2% bwob to about 3% bwob, about 3% bwob to about 5% bwob, about 5% bwob to about 15% bwob, about 15% bwob to about 25% bwob, about 25% bwob to about 50% bwob, or any ranges therebetween.

To be effective, the spacer can have certain characteristics. For example, the spacer may be compatible with the displaced fluid and the cement. This compatibility may also be present at downhole temperatures and pressures. In some instances, it is also desirable for the spacer to leave surfaces in the wellbore water wet, thus facilitating bonding with the cement. A number of different rheological properties may be important in the design of a spacer, including yield point, plastic viscosity, gel strength, and shear stress, among others. While rheology can be important in spacer design, conventional spacers may not have the desired rheology at downhole temperatures. For instance, conventional spacers may experience undesired thermal thinning at elevated temperatures. As a result, conventional spacers may not provide the desired displacement in some instances or lead to poor suspension in other instances.

In some examples, the spacer dry blend may include a solid scouring material, for example, to scrub and facilitate removal of solid filter cake on wellbore surfaces. Examples of suitable solid scouring materials may include, but are not limited to, pumice, perlite, other volcanic glasses, fumed silica, and fly ash, among others. The solid scouring material may be present in the spacer dry blend in any suitable amount, including, but not limited to, an amount of about 1% bwob to about 99.9% bwob. In specific embodiments, the solid scouring material may be present in an amount of about 1% bwob to about 25% bwob, about 25% bwob to about 50% bwob, about 50% bwob to about 75% bwob, about 90% to about 99%, or any ranges therebetween.

In some examples, the spacer dry blend may include a biopolymer gum. Examples of suitable biopolymer gums may include, but are not limited to polysaccharides such as, xanthan gum, diutan gum, welan gum, scleroglucan gum, and combinations thereof. The biopolymer gum may be present in the spacer dry blend in any suitable amount, including, but not limited to, an amount of from about 0.01% by bwob (by weight of spacer dry blend) to about 5% bwob. Alternatively, from about 0.01% bwob to about 0.05% bwob, about 0.05% bwob to about 0.1% bwob, about 0.1% bwob to about 0.5% bwob, about 0.5% bwob to about 1% bwob, about 1% bwob to about 2% bwob, about 2% bwob to about 3% bwob, about 3% bwob to about 5% bwob, or any ranges therebetween.

The spacer fluid may further include a surfactant. Any of a variety of surfactants may be included that may be capable of wetting well surfaces (e.g., water- or oil-wetting), such as the wellbore wall and casing surface. In some embodiments, both a water-wetting surfactant and an oil-wetting surfactant may be included in the spacer fluid. Examples of suitable wetting surfactants may include alcohol ethoxylates, alcohol ethoxysulfates, alkyl phenol ethoxylates (e.g., nonyl phenol ethoxylates), glycol ethers, and combinations thereof. Certain of the wetting surfactants may be used as water-soluble salts. For example, the wetting surfactants may be selected from alkali metal, alkaline earth metal, ammonium, and alkanolammonium salts of alcohol ethoxylates, alcohol ethoxysulfates, and alkyl phenol ethoxylates. The surfactant may be present in the spacer dry blend in any suitable amount, including, but not limited to, an amount of from about 0.01% by bwob (by weight of spacer dry blend) to about 5% bwob. Alternatively, from about 0.01% bwob to about 0.05% bwob, about 0.05% bwob to about 0.1% bwob, about 0.1% bwob to about 0.5% bwob, about 0.5% bwob to about 1% bwob, about 1% bwob to about 2% bwob, about 2% bwob to about 3% bwob, about 3% bwob to about 5% bwob, or any ranges therebetween.

The spacer fluid may further include a dispersant. Without limitation, suitable dispersants may include any of a variety of commonly used cement dispersants, such as sulfonated dispersants; sulfonated polymer dispersants; naphthalene sulfonates; melamine sulfonates; sulfonated melamine formaldehyde condensate; sulfonated naphthalene formaldehyde condensate; sulfonate acetone formaldehyde condensate; ethoxylated polyacrylates; or combinations thereof. The dispersant may be present in the spacer dry blend in any suitable amount, including, but not limited to, an amount of from about 0.01% by bwob (by weight of spacer dry blend) to about 5% bwob. Alternatively, from about 0.01% bwob to about 0.05% bwob, about 0.05% bwob to about 0.1% bwob, about 0.1% bwob to about 0.5% bwob, about 0.5% bwob to about 1% bwob, about 1% bwob to about 2% bwob, about 2% bwob to about 3% bwob, about 3% bwob to about 5% bwob, or any ranges therebetween.

Spacer fluids may further include a weighting agent. Weighting agents may be included in the spacer dry blend, for example, to provide the spacer fluid with a desired density. Examples of suitable weighting agents include, for example, such as barite, manganese tetraoxide, iron oxide, calcium carbonate, or iron carbonate. Weighting agents may be included in any suitable amount, including, but not limited to, from about 1% bwob to about 99% bwob, about 50% bwob to about 99% bwob, or about 75% bwob to about 99% bwob based on a total weight of the spacer dry blend.

The spacer fluids generally should have a density suitable for a particular application. In some embodiments, the spacer fluids may have a density in the range of from about 4 pounds per gallon (“lb/gal”) (480 kg/m3) to about 24 lb/gal (2900 kg/m3). In other embodiments, the spacer fluids may have a density in the range of about 4 lb/gal (480 kg/m3) to about 17 lb/gal (2040 kg/m3). In yet other embodiments, the spacer fluids may have a density in the range of about 8 lb/gal (960 kg/m3) to about 13 lb/gal (1600 kg/m3), about 13 Ib/gal (1600 kg/m3) to about 20 lb/gal (2396 kg/m3). Embodiments of the spacer fluids may be foamed or unfoamed or include other means to reduce their densities known in the art, such as lightweight additives. Those of ordinary skill in the art, with the benefit of this disclosure, will recognize the appropriate density for a particular application.

The spacer may have a viscosity at surface temperature and pressure sufficient to allow it to suspend any particles additives, such as barite, while still allowing it to be pumped downhole. In the wellbore, the spacer may maintain a viscosity sufficient to allow it to suspend any particle additives, while still allowing it to circulate through and out of the wellbore. The spacer may further maintain a viscosity upon return to surface pressure or temperature sufficient to allow it to exit the wellbore. The spacer may also further maintain its viscosity to allow it to continue to suspend any particles additives, such as barite, until it reaches a holding tank, through any cleaning or testing process, or until it is returned to the wellbore, as applicable.

As previously described, the spacer dry blend may be combined with water to form a spacer fluid, which may then be introduced into the wellbore. The water used in an embodiment of the spacer fluids may include, for example, freshwater, saltwater (e.g., water containing one or more salts dissolved therein), brines, seawater, or any combination thereof. Generally, the water may be from any source, provided that the water does not contain an excess of compounds that may undesirably affect other components in the spacer fluid. The water is included in an amount sufficient to form a pumpable spacer fluid. In some embodiments, the water may be included in the spacer fluids in an amount in the range of from about 15 wt. % to about 95 wt. % based on a total weight of the spacer fluid. In other embodiments, the water may be included in the spacer fluids in an amount in the range of from about 25 wt. % to about 85 wt. % or about 50 wt. % to about 75 wt. % based on a total weight of the spacer fluid. The spacer dry blend may be included in the spacer fluid in any suitable amount, including about 5 wt. % to about 50 wt. %, about 10 wt. % to about 60 wt. %, or about 20 wt. % to about 50 wt. % based on a total weight of the spacer fluid.

Suitable spacer fluids may be prepared in accordance with any suitable technique. Without limitation, the desired quantity of water may be introduced into a mixer (e.g., a cement blender) followed by the spacer dry blend. Additional liquid additives and/or dry additives, if any, may be added to the water as desired prior to, or after, combination with the dry blend. This mixture may be agitated for a sufficient period of time to form a pumpable slurry. By way of example, pumps may be used for delivery of this pumpable slurry into the wellbore. As will be appreciated, the spacer fluid and/or the spacer dry blend may be prepared at the well site or prepared offsite and then transported to the well site. If prepared offsite, the spacer dry blend and/or spacer fluid may be transported to the well site using any suitable mode of transportation, including, without limitation, a truck, railcar, barge, or the like. Alternatively, the spacer fluid and/or spacer dry blend may be formulated at the well site, for example, where the components of the spacer fluid and/or spacer dry blend may be delivered from a transport (e.g., a vehicle or pipeline) and then mixed prior to placement downhole. As will be appreciated by those of ordinary skill in the art, with the benefit of this disclosure, other suitable techniques for preparing the spacer fluids may be used in accordance with embodiments.

An example method may include a method of displacing a first fluid from a wellbore, the wellbore penetrating a subterranean formation. The method may include providing a spacer fluid that comprises the thermally stable additive and water. One or more additives may also be included in the spacer fluid as discussed herein. The method may further comprise introducing the spacer fluid into the wellbore to displace at least a portion of the first fluid from the wellbore. In some examples, the spacer fluid may displace the first fluid from a wellbore annulus, such as the annulus between a pipe string and the subterranean formation or between the pipe string and a larger conduit. In some examples, the first fluid displaced by the spacer fluid includes a drilling fluid. By way of example, the spacer fluid may be used to displace the drilling fluid from the wellbore. In addition to displacement of the drilling fluid from the wellbore, the spacer fluid may also remove the drilling fluid from the walls of the wellbore. Additional steps in examples of the method may comprise introducing a pipe string into the wellbore, introducing a cement composition into the wellbore with the spacer fluid separating the cement composition and the first fluid. In an embodiment, the cement composition may be allowed to set in the wellbore. The cement composition may include, for example, cement, thermally stable additive, and water.

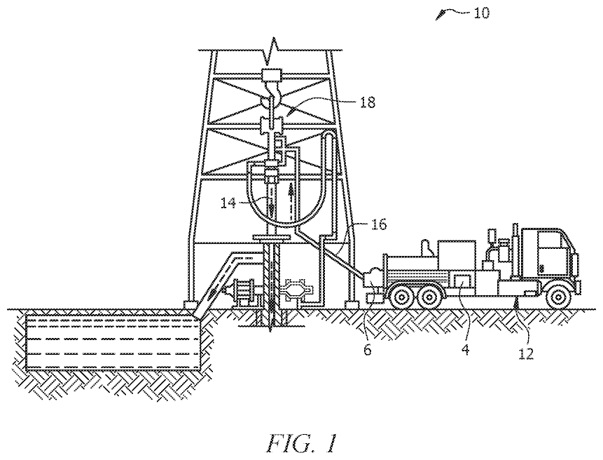

FIG. 1 illustrates example surface equipment 10 that may be used in placement of a spacer fluid and/or cement composition. It should be noted that while FIG. 1 generally depicts a land-based operation, however, the principles described herein are equally applicable to subsea operations that employ floating or sea-based platforms and rigs, without departing from the scope of the disclosure. As illustrated by FIG. 1, surface equipment 10 may include a cementing unit 12, which may include one or more cement trucks. The cementing unit 12 may include the mixing equipment 4 and pumping equipment 6. The cementing unit 12 may pump a spacer fluid and/or cement composition in the direction indicated by arrows 14 through a feed pipe 16 and to a cementing head 18 which conveys the fluid downhole. Any of the embodiments of a spacer fluid described herein may apply in the context of FIG. 1 with respect to the spacer fluid. For example, the spacer fluid may include the thermally stable additive, water, and one or more optional additives.

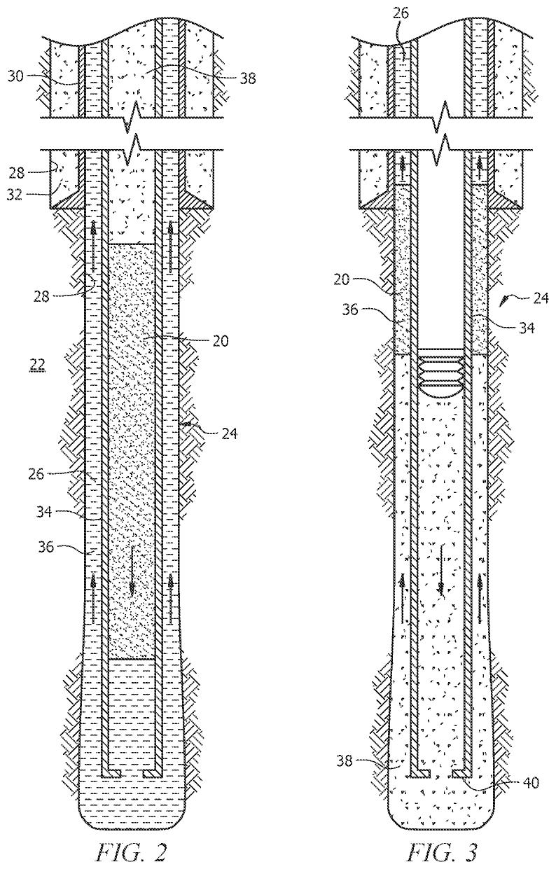

An example of using a spacer fluid 20 including the thermally stable additive will now be described with reference to FIG. 2. Any of the embodiments of a spacer fluid described herein may apply in the context of FIG. 2 with respect to the spacer fluid 20. For example, the spacer fluid 20 may include the thermally stable additive, water, and one or more optional additives. FIG. 2 depicts one or more subterranean formations 22 penetrated by a wellbore 24 with the drilling fluid 26 disposed therein. The drilling fluid 26 may include the example drilling fluids disclosed herein. While the wellbore 24 is shown extending generally vertically into the one or more subterranean formations 22, the principles described herein are also applicable to wellbores that extend at an angle through the one or more subterranean formations 22, such as horizontal and slanted wellbores. As illustrated, the wellbore 24 comprises the walls 28. In the illustrated embodiment, a surface casing 30 has been cemented to the walls 28 of the wellbore 24 by the cement sheath 32. In the illustrated embodiment, one or more additional pipe strings (e.g., intermediate casing, production casing, liners, etc.), shown here as a casing 34 may also be disposed in the wellbore 24. As illustrated, there is a wellbore annulus 36 formed between the casing 34 and walls 28 of the wellbore 24 (and/or the surface casing 30). While not shown, one or more centralizers may be attached to the surface casing 30, for example, to centralize the casing 34 in the wellbore 24 prior to and during the cementing operation.

As illustrated, a cement composition 38 comprising the thermally stable additive may be introduced into the wellbore 24. For example, the cement composition 38 may be pumped down the interior of the casing 34. The pump 6 shown on FIG. 1 may be used for delivery of the cement composition 38 comprising the thermally stable additive into the wellbore 24. It may be desired to circulate the cement composition 38 in the wellbore 24 until it is in the wellbore annulus 36. The cement composition 38 may include the example cement compositions disclosed herein. While not illustrated, other techniques may also be utilized for introduction of the cement composition 38. By way of example, reverse circulation techniques may be used that include introducing the cement composition 38 into the wellbore 24 by way of the wellbore annulus 36 instead of through the casing 34.

The spacer fluid 20 comprising the thermally stable additive may be used to separate the drilling fluid 26 from the cement composition 38 comprising the thermally stable additive. The previous embodiments described with reference to FIG. 1 for preparation of a spacer fluid may be used for delivery of the spacer fluid 20 into the wellbore 24. Moreover, the pump 6 as shown on FIG. 1 may also be used for delivery of the spacer fluid 20 into the wellbore 24. The spacer fluid 20 may be used with the cement composition 38 for displacement of the drilling fluid 26 from the wellbore 24 as well as preparing the wellbore 24 for the cement composition 38. By way of example, the spacer fluid 20 may function, inter alia, to remove the drilling fluid 26, the drilling fluid 26 that is dehydrated/gelled, and/or filter cake solids from the wellbore 24 in advance of the cement composition 38. While not shown, one or more plugs or other suitable devices may be used to physically separate the drilling fluid 26 from the spacer fluid 20 and/or the spacer fluid 20 from the cement composition 38.

Referring now to FIG. 3, the drilling fluid 26 has been displaced from the wellbore annulus 36 in accordance with certain embodiments. As illustrated, the spacer fluid 20 comprising the thermally stable additive and the cement composition 38 comprising the thermally stable additive may be allowed to flow down the interior of the casing 34 through the bottom of the casing 34 (e.g., the casing shoe 40) and up around the casing 34 into the wellbore annulus 36, thus displacing the drilling fluid 26. At least a portion of the displaced drilling fluid 26 may exit the wellbore annulus 36 via a flow line and be deposited, for example, in one or more retention pits. Turning back to FIG. 3, the cement composition 38 may continue to be circulated until it has reached a desired location in the wellbore annulus 36. The spacer fluid 20 and/or cement composition 38 may be left in the wellbore annulus 36. As illustrated, the spacer fluid 20 may be disposed in the wellbore annulus 36 above or on top of the cement composition 38. The cement composition 38 may set in the wellbore annulus 36 to form an annular sheath of hardened, substantially impermeable material (i.e., a cement sheath) that may support and position the casing 34 in the wellbore 24. As previously mentioned, embodiments of the spacer fluid 20 may consolidate in the wellbore annulus 36. Thus, the spacer fluid 20 may help to stabilize the casing 34 while also serving to provide a barrier to protect the portion of the casing 34 from corrosive effects of water and/or water-based drilling fluids that would otherwise remain in the wellbore annulus 36 above the cement composition 38.

The exemplary cement compositions including the thermally stable additive disclosed herein may directly or indirectly affect one or more components or pieces of equipment associated with the preparation, delivery, recapture, recycling, reuse, and/or disposal of the cement compositions and associated cement compositions. For example, the cement compositions may directly or indirectly affect one or more mixers, related mixing equipment, mud pits, storage facilities or units, composition separators, heat exchangers, sensors, gauges, pumps, compressors, and the like used to generate, store, monitor, regulate, and/or recondition the cement compositions. The disclosed cement compositions may also directly or indirectly affect any transport or delivery equipment used to convey the cement compositions to a well site or downhole such as, for example, any transport vessels, conduits, pipelines, trucks, tubulars, and/or pipes used to compositionally move the cement compositions from one location to another, any pumps, compressors, or motors (e.g., topside or downhole) used to drive the suspension additive, or fluids containing the same, into motion, any valves or related joints used to regulate the pressure or flow rate of the cement compositions, and any sensors (i.e., pressure and temperature), gauges, and/or combinations thereof, and the like. The disclosed cement compositions may also directly or indirectly affect the various downhole equipment and tools that may come into contact with the cement compositions such as, but not limited to, wellbore casings, wellbore liner, completion string, insert strings, drill string, coiled tubing, slickline, wireline, drill pipe, drill collars, mud motors, downhole motors and/or pumps, cement pumps, surface-mounted motors and/or pumps, centralizers, terrorizers, scratchers, floats (e.g., shoes, collars, valves, etc.), logging tools and related telemetry equipment, actuators (e.g., electromechanical devices, hydromechanical devices, etc.), sliding sleeves, production sleeves, plugs, screens, filters, flow control devices (e.g., inflow control devices, autonomous inflow control devices, outflow control devices, etc.), couplings (e.g., electro-hydraulic wet connect, dry connect, inductive coupler, etc.), control lines (e.g., electrical, fiber optic, hydraulic, etc.), surveillance lines, drill bits and reamers, sensors or distributed sensors, downhole heat exchangers, valves and corresponding actuation devices, tool seals, packers, cement plugs, bridge plugs, and other wellbore isolation devices, or components, and the like.

### EXAMPLES

The embodiments having been generally described, the following examples are given as particular embodiments of the disclosure and to demonstrate the practice and advantages thereof. It is understood that the examples are given by way of illustration and is not intended to limit the specification or the claims in any manner.

### Example 1

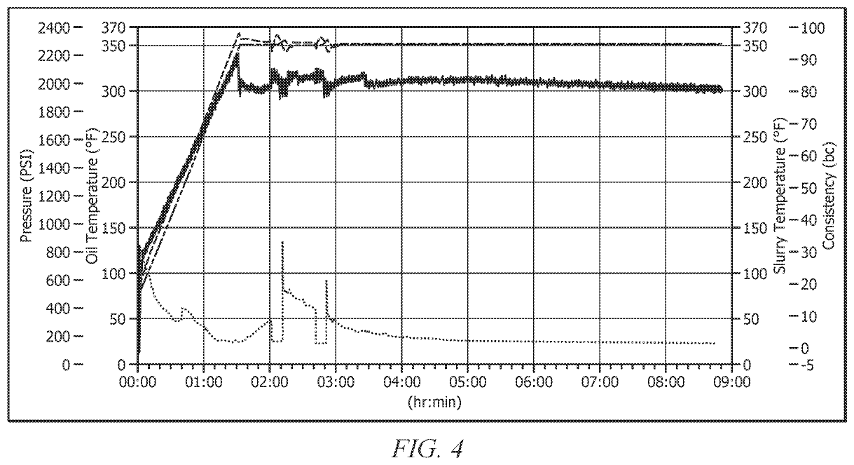

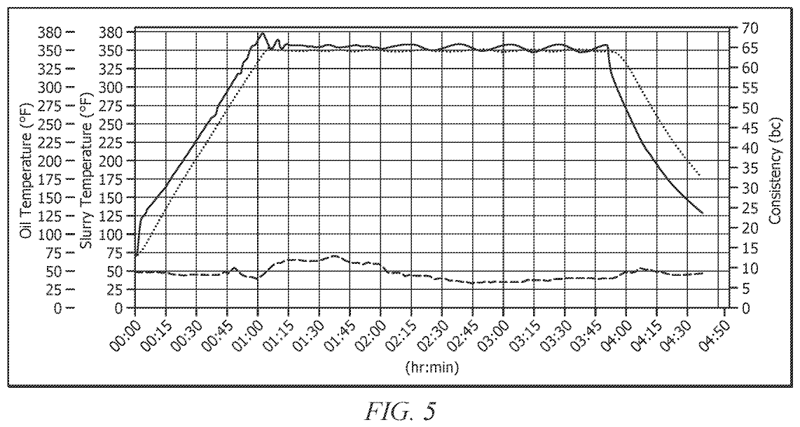

In this example, a thermally stable additive was tested in a cement. The thermally stable additive was a polymer containing a mixture of acrylamide/N-vinylpyrrolidone (Ac/NVP) in a mole ratio of 60:40 crosslinked with 2% N,N′-methylenebisacrylamide (MBA) and 2% triallyl isocyanurate (TTT). In one or more embodiments, a method of calculating the polymer entanglement concentration (P*) of the polymer mixture Ac/NVP in a mole ratio of 60:40 crosslinked with 2% MBA and 2% TTT based on titration data is illustrated in FIG. 4. Further, the cement was prepared according to Table 1 below. The minimization of P* can be determined by beginning with 100% t-butanol or n-butanol as the solvent system and a set concentration of reagents in a reaction vessel. Polymerizations can be conducted with varying amounts of water additions. The resulting polymer solution viscosities are measured in a serial dilution to determine P*. The value of P* continues to decrease as the water concentration is increased until the minimum is reached, after which, each additional increase in water concentration results in an increase in P*. Hence, the P* minimum can be identified. The thickening time of the cement slurries was then evaluated at 350° F. (178° C.) using a pressurized consistometer. It was observed that the 3.75 gram loading passed both shutdowns.

TABLE 1

| Material | Amount (grams) |
|---|---|
| Class H Cement | 500 |
| Weighting Agent | 372.3 |
| Silica | 175 |
| Fluid Loss Control Additive | 5 |
| Retarder | 5 |
| Potassium pentaborate tetrahydrade | 5 |
| Thermally stable additive | 3.75 |
| Water | 286.6 |

### Example 2

In this example, the thermally stable additive was tested in a spacer fluid. A first thermally stable additive was prepared using acrylamide and 2% triallyl isocyanurate. A first spacer fluid was prepared with 4 grams of the first thermally stable additive, 1 gram of polysaccharide-based suspension additive, 695.9 grams of barite, 34.24 grams of volcanic rock and 701.73 grams of water. The rheology of the first spacer fluid was tested at 80° F. using a Fann 35 viscometer. The results of the rheology test are shown in Table 2 where the first dial reading is the reading as RPMs are ramped up and the second dial reading is an RPMs are ramped down. A second spacer fluid was prepared with 1 gram of the polysaccharide-based suspension additive, 695.9 grams of barite, 34.24 grams of volcanic rock and 701.73 grams of water. The results of the rheology test are shown in Table 3.

The first spacer fluid was aged at 350° F. (177° C.) for a period of 30 minutes and 3.5 hours at 350° F. (177° C.) in a consistometer. The rheology of the first spacer fluid was measured at 80° F. (27° C.) after the 30 minutes and 3.5 hour mark and the data of which is shown in Table 4 and Table 5.

TABLE 2

| | | |
|---|---|---|
| RPM | Dial Reading | Avg. |

| | | | |
|---|---|---|---|
| 3 | 48.1 | 48.6 | 48.35 |
| 6 | 49.9 | 51.7 | 50.8 |
| 30 | 66 | 65.8 | 65.9 |
| 60 | 78.3 | 78.5 | 78.4 |
| 100 | 90.5 | 89.5 | 90 |
| 200 | 116 | 113.7 | 114.85 |
| 300 | 134 | | 134 |
| | | PV | 91.484 |
| | | YP | 44.72 |

TABLE 3

| | | |
|---|---|---|
| RPM | Dial Reading | Avg. |

| | | | |
|---|---|---|---|
| 3 | 10.8 | 12.8 | 11.8 |
| 6 | 13.1 | 14.5 | 13.8 |
| 30 | 18.1 | 19.2 | 18.65 |
| 60 | 23 | 23.6 | 23.3 |
| 100 | 27 | 27.3 | 27.15 |
| 200 | 35.8 | 35.8 | 35.8 |
| 300 | 42.9 | | 42.9 |
| | | PV | 15.07 |
| | | YP | 10.19 |

TABLE 4

| | | |
|---|---|---|
| RPM | Dial Reading | Avg |

| | | | |
|---|---|---|---|
| 3 | 36 | 35 | 35.5 |
| 6 | 47 | 47 | 47 |
| 30 | 94 | 95 | 94.5 |
| 60 | 126 | 127 | 126.5 |
| 100 | 156 | 155 | 155.5 |
| 200 | 205 | 203 | 204 |
| 300 | 241 | | 241 |
| | | PV | 374.5 |
| | | YP | 32.24 |

TABLE 5

| | | |
|---|---|---|
| RPM | Dial Reading | Avg |

| | | | |
|---|---|---|---|
| 3 | 10.7 | 9.2 | 9.95 |
| 6 | 19.4 | 11.3 | 15.35 |
| 30 | 43.6 | 38.4 | 41 |
| 60 | 60.6 | 55.1 | 57.85 |
| 100 | 73.6 | 68.9 | 71.25 |
| 200 | 93.6 | 92.8 | 93.2 |
| 300 | 109.5 | | 109.5 |
| | | PV | 152.7 |

### Example 3

A second thermally stable additive was prepared using acrylamide and N-vinylpyrrolidone in a 60:40 mole ratio with 2 mole % N,N′-methylenebisacrylamide crosslinker and 2 mole % triallyl isocyanurate crosslinker, each crosslinker mole percent based on the total moles of acrylamide and N-vinylpyrrolidone. A third spacer fluid was prepared with 5 grams of the second thermally stable additive 695.9 grams of barite, 34.24 grams of volcanic rock and 701.73 grams of water. The third spacer fluid was conditioned at 350° F. (177° C.) and the rheology was tested at 80° F. (27° C.) using a Fann 35 viscometer. The results of the rheology test are shown in Table 6. A graph of the results of the rheology test are shown in FIG. 5.

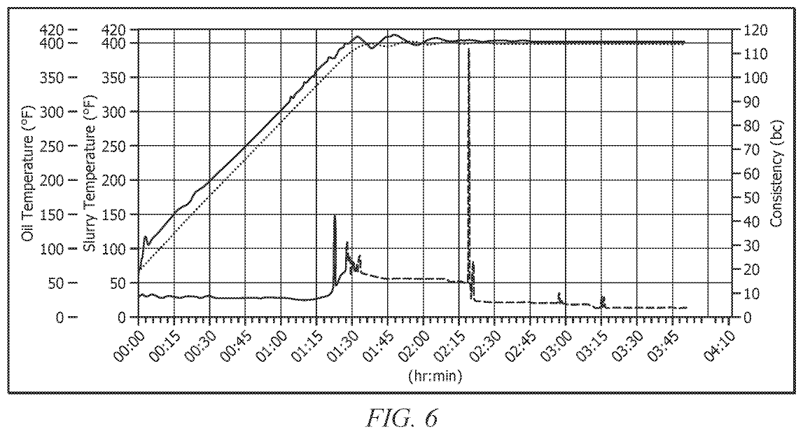

The third spacer fluid was further conditioned at 400° F. (204° C.) and the rheology was measured again. The results of the conditioning are shown in Table 7 and in FIG. 6.

TABLE 6

| | Dial Reading | |
|---|---|---|
| RPM | Mix | Conditioning (Cond.) |
| 3 | 20.8 | 25.85 |
| 6 | 23.4 | 34.45 |
| 30 | 32.1 | 69.55 |
| 60 | 40.9 | 93.55 |
| 100 | 48.6 | 111.85 |
| 200 | 65.9 | 147.05 |
| 300 | 80.9 | 172.9 |

TABLE 7

Dial Reading

| RPM | Mix | 400° F. Cond. |
|---|---|---|
| 3 | 20.8 | 30.2 |
| 6 | 23.4 | 42.8 |
| 30 | 32.1 | 84.05 |
| 60 | 40.9 | 113.2 |
| 100 | 48.6 | 134.65 |
| 200 | 65.9 | 175.1 |
| 300 | 80.9 | 206 |

### Example 4

A third thermally stable additive was prepared using acrylamide with 2% N,N′-methylenebisacrylamide crosslinker and 2% triallyl isocyanurate crosslinker. A fourth spacer fluid was prepared with 4 grams of the third thermally stable additive, 1 gram of a polysaccharide-based suspension additive 695.9 grams of barite, 34.24 grams of volcanic rock and 701.7 grams of water. The rheology of the fourth spacer fluid was evaluated and the results thereof are shown in Table 8. The fourth spacer fluid was conditioned at 350° F. (177° C.) for 3 hours and the rheology was tested at 80° F. (27° C.) using a Fann 35 viscometer. The results of the rheology test are shown in Table 9.

TABLE 8

| | | |
|---|---|---|
| RPM | Dial Reading | Avg. |

| | | | |
|---|---|---|---|
| 3 | 41.6 | 40.8 | 41.2 |
| 6 | 45.5 | 44.7 | 45.1 |
| 30 | 60 | 58.5 | 59.25 |
| 60 | 72.8 | 70.7 | 71.75 |
| 100 | 84.3 | 82.4 | 83.35 |
| 200 | 107.2 | 105.3 | 106.25 |
| 300 | 124.9 | | 124.9 |

TABLE 9

| | | |
|---|---|---|
| RPM | Dial Reading | Avg. |

| | | | |
|---|---|---|---|
| 3 | 33.8 | 19.3 | 26.55 |
| 6 | 35.3 | 23.9 | 29.6 |
| 30 | 60.3 | 42.1 | 51.2 |
| 60 | 102.5 | 64.7 | 83.6 |
| 100 | 128.2 | 84 | 106.1 |
| 200 | 133.5 | 113.7 | 123.6 |
| 300 | 136.6 | | 136.6 |

### Example 5

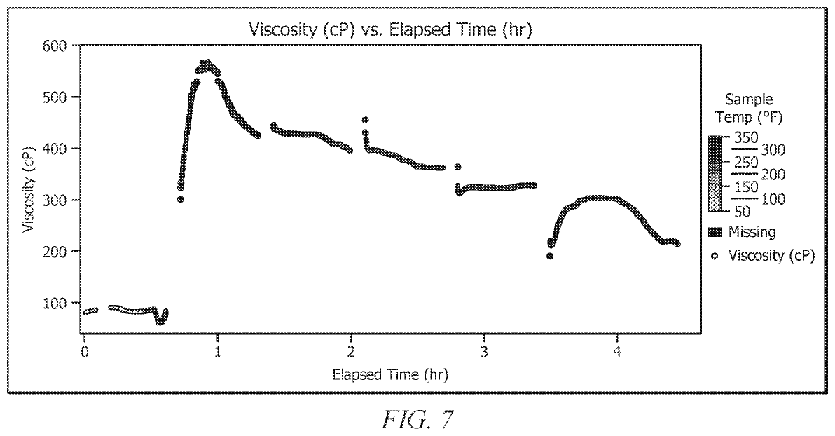

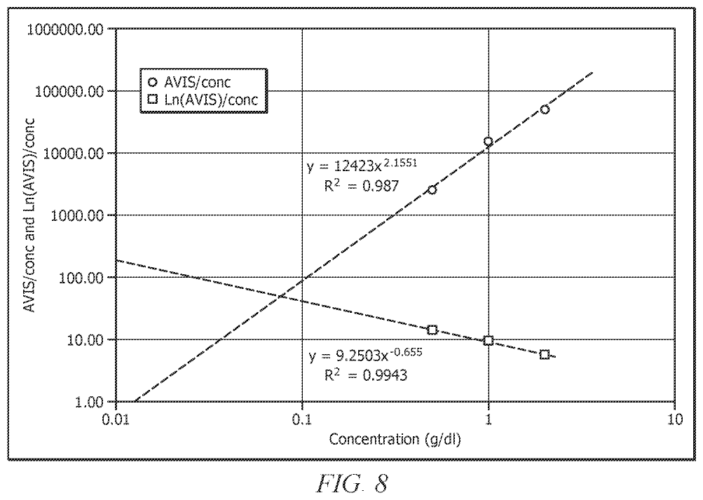

A fourth thermally stable additive was prepared using acrylamide with 2% N,N′-methylenebisacrylamide crosslinker and 2% triethylene glycol divinyl ether crosslinker. A fifth spacer fluid was prepared with 2.92 lb/bbl of the fourth thermally stable additive, 0.29 lb/bbl polysaccharide-based suspension additive, 20 lb/bbl volcanic rock, and blended to a density of 16 lb/gallon. The fifth spacer fluid was tested in a consistometer with a 350° F. (177° C.) sweep. The results of the test are shown in FIG. 7. It was observed that the spacer fluid gained viscosity with rising temperature.

### Example 6

In this example, a number of thermally stable additives were prepared and tested. The prepared thermally stable additives were tested in a clean spacer fluid using the formulation from Table 10, a spacer fluid with cement contamination using the spacer formulation from Table 11, a spacer fluid design for longevity testing using the formulation in Table 12, and a water yielding fluid using the formulation in Table 13. The formulation for the thermally stable additives is shown in Table 14. The thermally stable additives include polyacrylamide (PAC), polyacrylamide/2-acrylamido-2-methyl-1-propanesulfonic acid (PAc/AMPS), 2-acrylamido-2-methyl-1-propanesulfonic acid/N-vinylpyrrolidone (AMPS/NVP), acrylamide/N-vinylpyrrolidone (Ac/NVP), and N-vinylpyrrolidone (NVP). The results of the tests are shown in Table 15.

TABLE 10

| Spacer Design 16 ppg | Mass (g) | lb/bbl |
|---|---|---|
| Volcanic Rock | 17.118 | 20 |
| Barite | 347.95 | 406.53 |
| Polysaccharide-based suspension additive | 1 | 0.6 |
| Thermally stable additive | 5 | 2.9 |
| Water | 210.098 | 245.47 |

TABLE 11

| Spacer Design w/Cement Contamination | Mass (g) |
|---|---|
| Cement | 6.85 |
| Retarder | 0.1 |
| Barite | 139.18 |
| Polysaccharide-based suspension additive | 1 |
| Thermally stable additive | 5 |
| Water | 84.04 |

TABLE 12

| Spacer Design for longevity testing | Mass (g) |
|---|---|
| Cement | 6.85 |
| Barite | 6.85 |
| Polysaccharide-based suspension | 0.2 |
| Thermally stable additive | 2 |
| Water | 84.04 |

TABLE 13

| Water Yielding Test | Mass (g) |
|---|---|
| Water | 100 |
| Thermally stable additive | 1 |

To facilitate a better understanding of the present disclosure, the following examples of some embodiments are given. In no way should such examples be read to limit, or to define, the scope of the disclosure.

TABLE 14

| | | Monomers (mol %) | | | Crosslinkers (mol %) | | | |
|---|---|---|---|---|---|---|---|---|
| | | | 2-acrylamido- | | | Triethylene | | |
| | | | 2-methyl-1- | | N,N′- | glycol | | |
| | | | propanesulfonic | N- | Methylene- | divinyl | triallyl | Pentaerythritol |
| | Polymer | Acrylamide | acid | vinylpyrrolidone | bisacrylamide | ether | isocyanurate | allyl ether |
| | No. | (AM) | (AMPS) | (NVP) | (MBA) | TEGDVE) | (TTT) | (PEAE) |
| PAc(1% MBA) | 1 | 100 | | | 1 | | | |
| PAc(2% MBA) | 2 | 100 | | | 2 | | | |
| PAc(4% MBA) | 3 | 100 | | | 4 | | | |
| PAc(6% MBA) | 4 | 100 | | | 6 | | | |
| PAc(4% MBA/2% | 5 | 100 | | | 4 | 2 | | |
| TEGDVE) | | | | | | | | |
| PAc(2% MBA/2% | 6 | 100 | | | 2 | 2 | | |
| TEGDVE) | | | | | | | | |
| PAc(2% TTT) | 7 | 100 | | | | | 2 | |
| PAc(3% TTT) | 8 | 100 | | | | | 3 | |
| PAc(4% TTT) | 9 | 100 | | | | | 4 | |
| PAc(5% TTT) | 10 | 100 | | | | | 5 | |
| PAc(2% TTT/2% | 11 | 100 | | | 2 | | 2 | |
| MBA) | | | | | | | | |
| Ac/AMPS(2% MBA/ | 12 | 50 | 50 | | 2 | | 2 | |
| 2% TTT) | | | | | | | | |
| Ac/AMPS(4% TTT) | 13 | 50 | 50 | | | | 4 | |
| Ac/AMPS(2% TTT) | 14 | 50 | 50 | | | | 2 | |
| AMPS/NVP(80:20) | 15 | | 80 | 20 | 1 | | 5 | |
| 1% MBA, 5% TTT | | | | | | | | |
| AMPS/NVP(80:20) | 16 | | 80 | 20 | 2 | | 4 | |
| 2% MBA, 4% TTT | | | | | | | | |
| AMPS/NVP(80:20) | 17 | | 80 | 20 | 1 | | 2 | |
| 2% MBA, 4% TTT | | | | | | | | |
| AMPS/NVP(80:20) | 18 | | 80 | 20 | | | 2 | |
| 2% TTT | | | | | | | | |
| AMPS/NVP(80:20) | 19 | | 80 | 20 | | | 4 | |
| 4% TTT | | | | | | | | |
| AMPS/NVP(80:20) | 20 | | 80 | 20 | 2 | | 2 | |
| 2% MBA, 2% TTT | | | | | | | | |
| AMPS/NVP (80:20) | 21 | | 80 | 20 | | | | |
| AMPS/NVP (50:50) | 22 | | 50 | 50 | | | | |
| Ac/NVP(60; 40) | 23 | 60 | | 40 | 2 | | 2 | |
| 2% MBA, 2% TTT | | | | | | | | |
| Ac/NVP(80; 20) | 24 | 80 | | 20 | 2 | | 2 | |
| 2% MBA, 2% TTT | | | | | | | | |
| Ac/NVP(60; 40) | 25 | 60 | | 40 | 1 | | 1 | |
| 1% MBA, 1% TTT | | | | | | | | |
| Ac/NVP(60; 40) | 26 | 60 | | 40 | 2 | | | 2 |
| 2% MBA, 2% PEAE | | | | | | | | |
| Ac/NVP(50; 50) | 27 | 50 | | 50 | 2 | | 2 | |
| 2% MBA, 2% TTT | | | | | | | | |
| Ac/NVP(40; 60) | 28 | 40 | | 60 | 2 | | 2 | |
| 2% MBA, 2% TTT | | | | | | | | |
| NVP 2% MBA, 2% | 29 | | | 100 | 2 | | 2 | |
| TTT | | | | | | | | |

TABLE 15

| Spacer Testing | | | | | | | | Spacer | |
|---|---|---|---|---|---|---|---|---|---|
| | | | | Peak | | | | longevity | |
| | | | | Viscosity | | Exposure | | Survived at | Cement |
| | | Yielding | Yielding | @ 100 | FYSA | duration | | 350° F. for | Contamination |
| Polymer | | Temperature | peak | rpm | (yes(y)/ | @ 400° F. | | 4 hr | Survival |
| No. | Concentration | (° F.) | (° F.) | (cP) | no(n)) | (hr) | Degradation? | (y/n) | (y/n) |
| 1 | 5 g/600 mL | 309 | 391 | 567 | y | 1 | n | y | |
| 2 | 5 g/600 mL | 346 | 391 | 430 | y | 1.5 | n | | n |
| 3 | 5 g/600 mL | 325 | 391 | 689 | y | 1 | n | | |
| 4 | 5 g/600 mL | 363 | 391 | 420 | y | 1.5 | n | | |
| 5 | 5 g/600 mL | 326 | 391 | 529 | y | 0.5 | n | y | |
| 6 | 5 g/600 mL | 341 | 391 | 600 | y | 0.5 | n | | |
| 7 | 2.5 g/600 mL | 372 | 391 | 343 | y | 1 | n | | |
| 8 | 5 g/600 mL | | | | | | | | |
| 9 | 5 g/600 mL | 336 | 391 | 357 | y | 1.5 | n | | |
| 10 | 5 g/600 mL | 299 | 391 | 373 | y | 1.5 | n | | |
| 11 | 5 g/600 mL | 346 | 391 | 214 | y | 1.5 | n | | |
| 12 | 5 g/600 mL | 374 | 391 | 85 | y | 1.5 | n | | |
| 13 | 5 g/600 mL | | | | | | | | |
| 14 | | 316 | 391 | 687 | y | 1 | n | | |
| 15 | 5 g/600 mL | 311 | 391 | 247 | y | 1 | n | | y |
| 16 | 5 g/600 mL | 312 | 391 | 366 | y | | | | y |
| 17 | 5 g/600 mL | 318 | 383 | 334 | y | 0.5 | n | | |
| 18 | 5 g/600 mL | 316 | 391 | 682 | y | 1 | n | y | n |
| 19 | | 323 | 391 | 350 | y | 1.5 | n | y | |
| 20 | 5 g/600 mL | 319 | 378 | 307 | y | 1.5 | n | y | |
| 21 | 5 g/600 mL | 309 | 391 | 567 | y | 1 | n | | |
| 22 | 5 g/600 mL | 346 | 391 | 430 | y | 1.5 | n | | |
| 23 | 5 g/600 mL | 325 | 391 | 689 | y | 1 | n | | |
| 24 | 5 g/600 mL | 363 | 391 | 420 | y | 1.5 | n | y | |
| 25 | 5 g/600 mL | 326 | 391 | 529 | y | 0.5 | n | | |
| 26 | 5 g/600 mL | 341 | 391 | 600 | y | 0.5 | n | | |

### Example 7

In this Example, polymer entanglement concentration (P*) was measured for a Ac/NVP (60:40) 2% MBA 2% TTT polymer. A 1 g amount of polymer was dispersed in 50 g of deionized water. The solution was placed in a Chandler 5550 rheometer (e.g., pressurized rotational viscometer) with an R1/B5X bob geometry and sheared at 100 rpm for the duration of the experiment. The solution was heated to 400° F. (204° C.) over 20 minutes while keeping a constant 1000 psi of nitrogen pressure. The solution was held at 400° F. (204° C.) for 40 minutes and then cooled to room temperature. The resulting solutions with yielded polymer were then used to preform the apparent viscosity (AVIS) measurements.

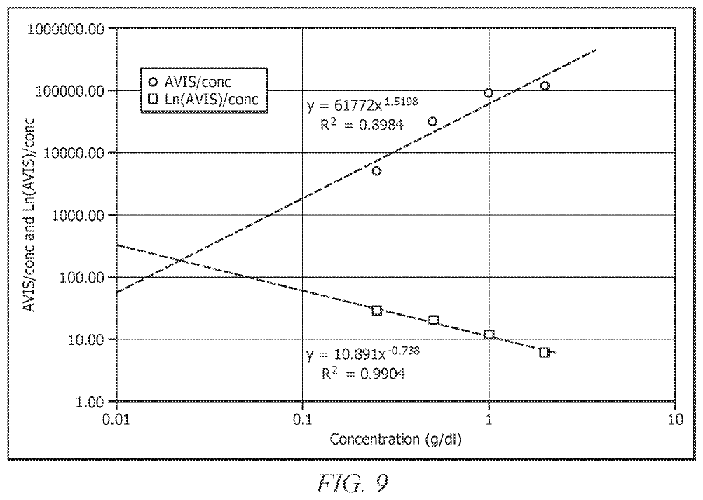

As depicted in FIGS. 8-14, the dependent variable y refers to the variable that is being predicted or estimated. In other words, it is the variable that is being modeled as a function of one or more independent variables. R-squared, also known as the coefficient of determination, is a statistical measure that represents the proportion of the variance in the dependent variable that is predictable from the independent variable(s). It is a value between 0 and 1, with higher values indicating a better fit between the model and the data.

For each of the FIGS. 8-14, respectively, the wt./wt. ratio % of water to butanol, either n-butanol or t-butanol, is as depicted below in TABLE 16:

TABLE 16

| | | | Water to Butanol |
|---|---|---|---|
| | Butanol | Water Amount | Amount |
| FIG. | Type | (mL) | (wt./wt. %) |
| 8 | n-butanol | 15 | 7.9 |
| 9 | n-butanol | 10 | 5.3 |
| 10 | n-butanol | 5 | 2.6 |
| 11 | n-butanol | 0 | 0 |
| 12 | t-butanol | 0 | 0 |
| 13 | t-butanol | 5 | 2.6 |
| 14 | t-butanol | 7.5 | 7.9 |

Serial dilutions of three to four iterations of the polymer Ac/NVP (60:40) 2% MBA 2% TTT were measured at a shear rate of 1 rpm. The results of the AVIS measurements are shown in Table 17. A line of best fit was calculated using linear least squares for AVIS/concentration and Ln (AVIS)/concentration and the intercept polymer entanglement concentration (P*) was calculated. FIGS. 8-14 are visual plots of the data from Table 17 and P* calculation.

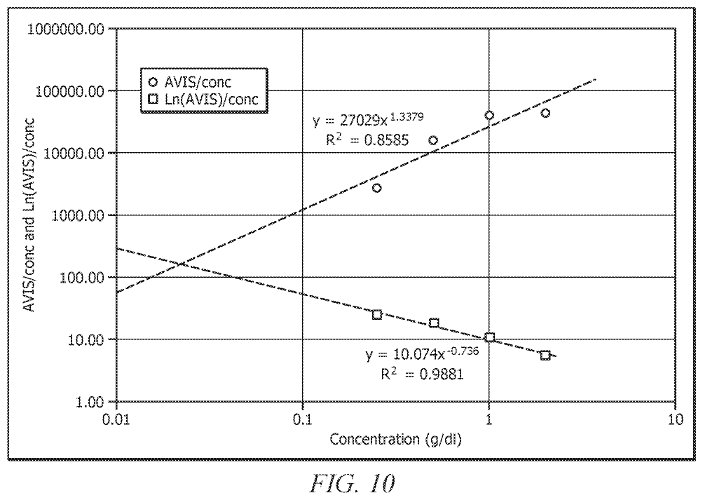

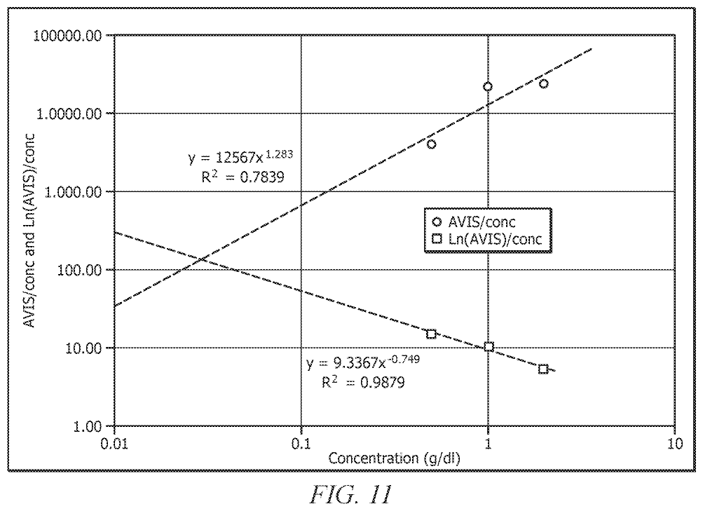

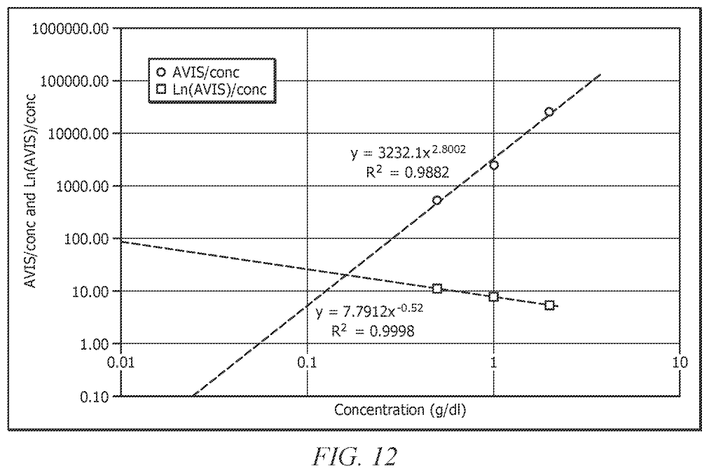

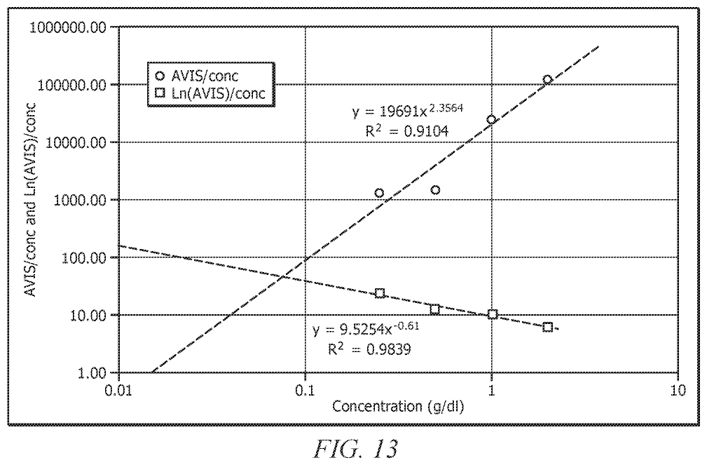

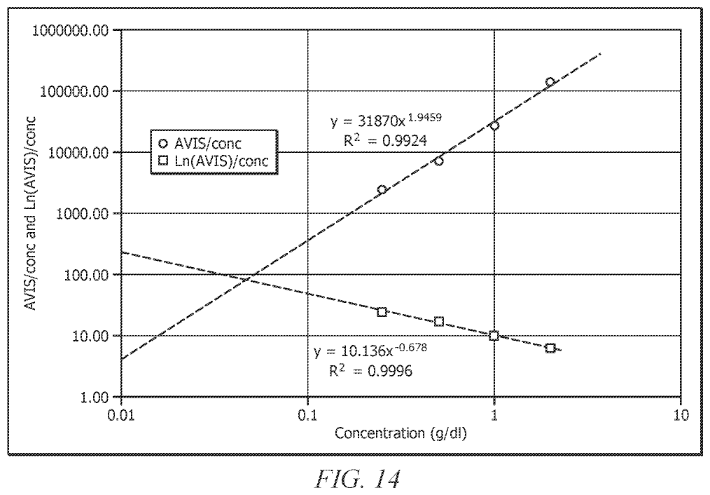

TABLE 17

| Lot (H₂O amount, | | | | | | | | |
|---|---|---|---|---|---|---|---|---|
| cosol-vent | | Concentration | Concentration | | | AVIS/ | Ln(AVIS)/ | P* |
| (190 mL)) | FIG. | (g/mL) | (g/dL) | AVIS | Ln(AVIS) | conc | conc | (dL) |
| 0 mL, Tert | FIG. 12 | 0.02 | 2 | 50880 | 10.84 | 25440.00 | 5.42 | 0.1630 |
| | | 0.01 | 1 | 2531 | 7.84 | 2531.00 | 7.84 | |
| | | 0.005 | 0.5 | 262.186 | 5.57 | 524.37 | 11.14 | |
| | | 0.0025 | 0.25 | | | | | |
| 2.5 mL, Tert | | 0.02 | 2 | 122159 | 11.71 | 61079.50 | 5.86 | 0.1265 |
| | | 0.01 | 1 | 31504 | 10.36 | 31504.00 | 10.36 | |
| | | 0.005 | 0.5 | 511 | 6.24 | 1022.00 | 12.47 | |
| | | 0.0025 | 0.25 | | | | | |
| 5 mL, Tert | FIG. 13 | 0.02 | 2 | 240987.0 | 12.39 | 120493.50 | 6.20 | 0.0763 |
| | | 0.01 | 1 | 24316.0 | 10.10 | 24316.00 | 10.10 | |
| | | 0.005 | 0.5 | 739.0 | 6.61 | 1478.00 | 13.21 | |
| | | 0.0025 | 0.25 | 331.0 | 5.80 | 1324.00 | 23.21 | |
| 7.5 mL, Tert | FIG. 14 | 0.02 | 2 | 281539 | 12.55 | 140769.50 | 6.27 | 0.0465 |
| | | 0.01 | 1 | 27514 | 10.22 | 27514.00 | 10.22 | |
| | | 0.005 | 0.5 | 3683 | 8.21 | 7366.00 | 16.42 | |
| | | 0.0025 | 0.25 | 609 | 6.41 | 2436.00 | 25.65 | |
| 0 mL, nBut | FIG. 11 | 0.02 | 2 | 46707.0 | 10.75 | 23353.50 | 5.38 | 0.0609 |
| | | 0.01 | 1 | 21548.0 | 9.98 | 21548.00 | 9.98 | |
| | | 0.005 | 0.5 | 1972.0 | 7.59 | 3944.00 | 15.17 | |
| | | 0.0025 | 0.25 | | | | | |
| 5 mL, nBut | FIG. 10 | 0.02 | 2 | 89812.0 | 11.41 | 44906.00 | 5.70 | 0.0222 |
| | | 0.01 | F1 | 41024.0 | 10.62 | 41024.00 | 10.62 | |
| | | 0.005 | 0.5 | 8175.0 | 9.01 | 16350.00 | 18.02 | |
| | | 0.0025 | 0.25 | 693.2748 | 6.54 | 2773.10 | 26.17 | |
| 10 mL, nBut | FIG. 9 | 0.02 | 2 | 238428 | 12.38 | 119214.01 | 6.19 | 0.0218 |
| | | 0.01 | 1 | 91770.22 | 11.43 | 91770.22 | 11.43 | |
| | | 0.005 | 0.5 | 16008.95 | 9.68 | 32017.89 | 19.36 | |
| | | 0.0025 | 0.25 | 1263.821 | 7.14 | 5055.29 | 28.57 | |
| 15 mL, nBut | FIG. 8 | 0.02 | 2 | 100226.4 | 11.52 | 50113.19 | 5.76 | 0.0771 |
| | | 0.01 | 1 | 15145.91 | 9.63 | 15145.91 | 9.63 | |
| | | 0.005 | 0.5 | 1263.14 | 7.14 | 2526.28 | 14.28 | |
| | | 0.0025 | 0.25 | | | | | |

### Example 8

As depicted in TABLE 18 below, multiple samples are polymerized with varying amounts of water and n-butanol or t-butanol. A total of sixteen samples of the resultant polymers are made, with some of the sixteen samples subjected to a viscosity test.

TABLE 18

| | | | Viscosity of |
|---|---|---|---|
| | | | 1 wt. % |
| | H₂O | H₂O | Solution |
| | (mL) | (vol. %) | (cP) |
| n-Butanol (mL) | | | |
| 190 | 0 | 0 | 316 |
| 190 | 2.5 | 1 | |
| 190 | 5 | 3 | 1226 |
| 190 | 7.5 | 4 | 2046 |
| 190 | 10 | 5 | 2749 |
| 190 | 12.5 | 6 | 2141 |
| 190 | 15 | 7 | 1119 |
| 190 | 20 | 10 | 544 |
| t-Butanol (mL) | | | |
| 190 | 0 | 0 | 687 |
| 190 | 2.5 | 1 | 2668 |
| 190 | 5 | 3 | 3159 |
| 190 | 7.5 | 4 | 2133 |
| 190 | 10 | 5 | 435 |
| 190 | 12.5 | 6 | |
| 190 | 15 | 7 | |
| 190 | 20 | 10 | 98 |

Thirteen samples of the resultant polymers are evaluated by creating a 1% bwow solution of each of the thirteen polymers in a Chandler Engineering 5550 viscometer. Chandler Engineering is a subsidiary of Ametek, Inc. of Berwyn, PA. The polymer product is insoluble in water at room temperature so samples are heated to obtain measurements.

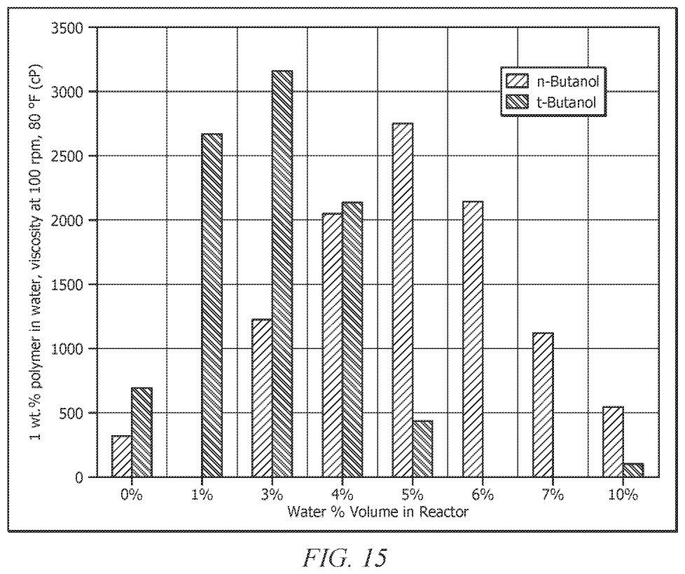

A rotational R1B5X bob is utilized on the Chandler 5550 viscometer. For each sample, 0.5 g of polymer is placed in 50 ml of deionized water in the chamber. Subsequently, the chamber is pressurized to 1,000 psi with nitrogen. The chamber is heated for 20 minutes until 400° C. (204° C.) is reached and held for 40 minutes at that temperature. After 40 minutes, the heat is removed and the sample is allowed to cool. During the entire heating and cooling process, viscosity measurements are taken and the maximum viscosity measurement is recorded for each of the thirteen samples as depicted in FIG. 15.

As depicted, t-butanol exhibits the highest viscosity for polymers made with about 1 to about 5 volume percent, or about 1 to about 4 volume percent, water and n-butanol made with about 4 to about 6 volume percent water. A polymer made in these ranges can impart a viscosity of about two to about twelve, or about four to about eight, times higher than a polymer made with water outside these ranges, including without water. Although not wanting to be bound by theory, the addition of a predetermined amount of water optimizes the polymerization time to obtain a polymer of desired molecular weight to be suited as a viscosifier at a high temperature.

### Example 9

In this example, three thermally stable additives were tested in a cement. Each of the first and second thermally stable additives (first and second samples) was a polymer containing a mixture of acrylamide/N-vinylpyrrolidone (Ac/NVP) in a mole ratio of 60:40 crosslinked with 0.35 mole % TTT and 0.6 mole % PEAE, each crosslinker mole percent based on the total moles of acrylamide and N-vinylpyrrolidone. The third thermally stable additive (comparative sample) was a polymer containing a mixture of acrylamide/N-vinylpyrrolidone (Ac/NVP) in a mole ratio of 60:40 crosslinked with 2 mole % N,N′-methylenebisacrylamide (MBA) and 2 mole % triallyl isocyanurate (TTT), each crosslinker mole percent based on the total moles of acrylamide and N-vinylpyrrolidone. The first thermally stable additive was present at 1% BWOW in a cement, the second thermally stable additive was present at 2% BWOW in a cement, and the third thermally stable additive was present at 1% BWOW in a cement. The water and cement are substantially the same for all three samples, as well as the conditions for preparing the thermally stable additives and the cements, including the incorporation of the additives in the cements.

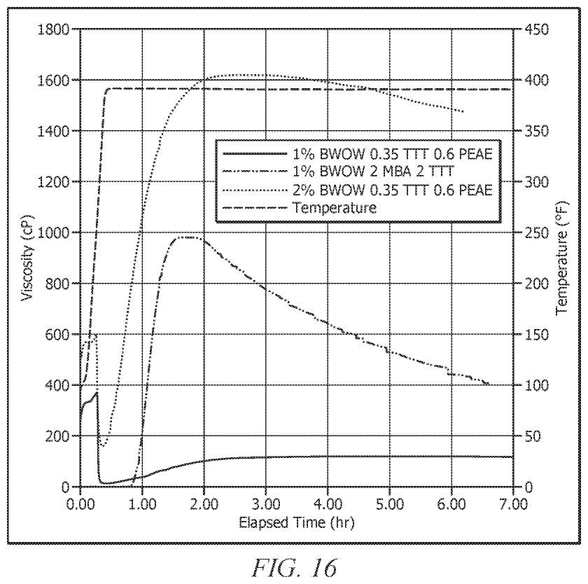

Referring to FIG. 16, the three samples were continuously measured for viscosity with a temperature rising until held at a final temperature for 7 hours. Specifically, the temperature for the samples was ramped from an initial temperature of about 70° F. (21° C.) to about 110° F. (43° C.) to a final temperature of about 400° F. (204° C.) in about 30 minutes and held at the final temperature for about 7 hours. Sample 2 and the comparative sample reached a peak viscosity of, respectively, about 1618 cP and 980 cP. Over a period of about 5 hours, Sample 2 only dropped about 145 cP from its peak viscosity while the comparative sample dropped about 572 cP from its peak. Thus, sample 2 only had a loss of viscosity of about 9% from its peak over 5 hours at 400° F. (204° C.), while the comparative example had a loss of viscosity of 42% for its peak over 5 hours at 400° F. (204° C.). It should be noted that sample 1 did not reach a peak viscosity after 7 hours, but did exhibit thermal stability over a period of 3 hours to 7 hours at a temperature at 400° F. (204° C.). Although not wanting to be bound by theory, a thermally stable crosslinker with four functional groups appears to exhibit significant and unexpected results over a crosslinker with no more than three functional groups for maintaining viscosity at a high temperature, such as 400° F. (204° C.).

### Example 10

In this example, two thermally stable additives were tested in a cement. Each of the first and second thermally stable additives (first and second samples) was a polymer containing a mixture of acrylamide/N-vinylpyrrolidone (Ac/NVP) in a mole ratio of 60:40 with the first sample crosslinked 0.35 mole % TTT and 0.6 mole % PEAE (70), and the second sample crosslinked 0.4 mole % TTT and 0.6 mole % PEAE (70), each crosslinker mole percent based on the total moles of acrylamide and N-vinylpyrrolidone. The PEAE (70) has a purity of 70% pentaerythritol triallyl ether, by mole, with the remaining 30%, by mole, being a mixture of pentaerythritol tetraallyl ether and pentaerythritol diallyl ether. The first and second thermally stables additive were present at 1% BWOW in a cement. The water and cement are substantially the same for all three samples, as well as the conditions for preparing the thermally stable additives and the cements, including the incorporation of the additives in the cements.

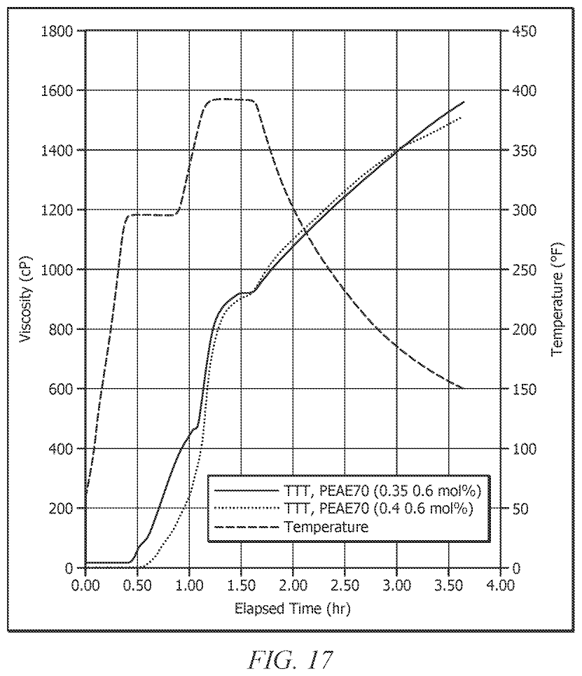

Referring to FIG. 17, the two samples were continuously measured for viscosity with a temperature rising until held at a final temperature for 4 hours. Specifically, the temperature for the samples was ramped from an initial temperature of about 70° F. (21° C.) to about 300° F. (150° C.) and held for a 30 minute period of time to establish the yielding time, then a second ramp to a final temperature of about 400° F. (204° C.) to fully yield the polymer. As depicted, the concentration of the tetra-functional crosslinker does not change the viscosity onset, but only the final viscosity

Accordingly, the present disclosure is related to a thermally stable additive and methods of using the thermally stable additive in wellbore operations.

### ADDITIONAL DISCLOSURE

The following are non-limiting, specific embodiments in accordance with the present disclosure:

A first embodiment which is a method for preparing a wellbore treatment fluid, comprises contacting a fluid with a high temperature suspension additive to form the wellbore treatment fluid, wherein the high temperature suspension additive is a reaction product of at least one monomer, a thermally unstable crosslinker, and a thermally stable crosslinker comprising a compound with at least four functional groups, and wherein the high temperature suspension additive maintains a viscosity of the wellbore treatment fluid at a temperature of at least 250° F. (121° C.) for at least about 4 hours with a viscosity equal to or greater than about 25%, about 13%, or about 9.0% of a peak viscosity.

A second embodiment which is the method of the first embodiment, wherein the monomer polymerizes to provide a plurality of polymer chains and wherein at least some of the four functional groups in each thermally stable crosslinker molecule provide a resultant 4-way cross-linking of the polymer chains with each of the four functional groups of each thermally stable crosslinker molecule cross-linking with the same or different polymer chain.

A third embodiment which is the method of the first embodiment or second embodiment, wherein some of the thermally stable crosslinker forms at least four single bonds with adjacent groups (e.g., wherein the adjacent groups are located on polymer chains and single bonds crosslink the polymer chains).

A fourth embodiment which is the method of any of the proceeding embodiments, wherein the thermally stable crosslinker has the following chemical formula:

[A]-[B]_{y}

wherein:
A is a pentaerythritol moiety, a ethylenediamine moiety, a tetraallylammonium moiety, or a disaccharide moiety;
B is, independently, a propenyl or an isobutenyl, optionally substituted by an oxo group; and
y is an integer ranging from 4 to 16.

A fifth embodiment which is the method of the fourth embodiment, wherein y is an integer ranging from 4 to 8.

A sixth embodiment which is the method of the fourth embodiment or fifth embodiment, wherein the disaccharide moiety is a sucrose moiety, a lactose moiety, a maltose moiety, a trehalose moiety, a cellobiose moiety, a chitobiose moiety, or a combination thereof.

A seventh embodiment which is the method of any of the fourth to sixth embodiments, wherein the disaccharide moiety comprises a sucrose moiety.

An eighth embodiment which is the method of any of the proceeding embodiments, wherein the high temperature suspension additive has an operative temperature range greater than a high temperature suspension additive crosslinked with a thermally stable crosslinker absent a compound with at least four functional groups.

A ninth embodiment which is the method of any of the proceeding embodiments, wherein the high temperature has a lower limit of about 250° F. (121° C.), about 275° F. (135° C.), about 300° F. (149° C.), about 325° F. (163° C.), about 350° F. (177° C.), about 400° F. (204° C.), or about 450° F. (232° C.) to an upper limit of about 550° F. (288° C.), about 500° F. (260° C.), about 450° F. (232° C.), or about 400° F. (204° C.).

A tenth embodiment which is the method of any of the proceeding embodiments, further comprising placing the wellbore treatment fluid downhole with a bottom hole static temperature (BHST) ranging from a lower limit of about 250° F. (121° C.), about 275° F. (135° C.), about 300° F. (149° C.), about 325° F. (163° C.), about 350° F. (177° C.), about 400° F. (204° C.), or about 450° F. (232° C.) to an upper limit of about 550° F. (288° C.), about 500° F. (260° C.), about 450° F. (232° C.), or about 400° F. (204° C.).

An eleventh embodiment which is the method of any of the proceeding embodiments, wherein the thermally stable crosslinker has the following formula:

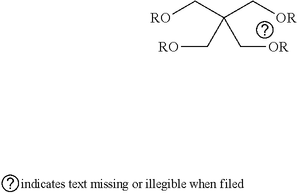

wherein R is

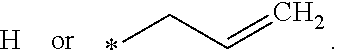

A twelfth embodiment which is the method of any of the proceeding embodiments, wherein the compound with the at least four functional groups comprises pentaerythritol, pentaerythritol tetra(meth)acrylate, pentaerythritol tetraallyl ether, allyl sucrose, tetraallylethylene diamine, tetraallylammonium chloride, tetraallyl orthosilicate, 1,3,5,7-tetravinyl-1,3,5,7-tetramethylcyclotetrasiloxane, or a combination thereof.

A thirteenth embodiment which is the method of any of the proceeding embodiments, wherein the compound with the at least four functional groups comprises pentaerythritol tetraallyl ether.

A fourteenth embodiment which is the method of any of the proceeding embodiments, wherein each of the at least four functional groups comprises, independently, a hydroxy or a propenyl.

A fifteenth embodiment which is the method of any of the proceeding embodiments, wherein the thermally unstable crosslinker comprises at least one functional group and not more than three functional groups.

A sixteenth embodiment which is the method of any of the proceeding embodiments, wherein the thermally unstable crosslinker comprises triallyl isocyanurate, N, N-methylenebisacrylamide, divinyl ether, diallyl ether, ethylene glycol divinyl ether, triethylene glycol divinyl ether, diethylene glycol divinyl ether, glycerol diallyl ether, polyethylene glycol divinyl ether, propylene glycol divinyl ether, trimethylolpropane diallyl ether, divinylbenzene, 1,3-divinylimidazolidin-2-one, divinyltetrahydropyrimidin-2 (1H)-one, a diene, an allyl amine, N,N′-methylenebismethacrylamide, N,N′-ethylenebisacrylamide, N,N′-propylenebisacrylamide, N,N′-(1,2-dihydroxyethylene)bisacrylamide, 1,4-diacryloylpiperazine, N,N-diallylacrylamide, 1,3,5-triacryloylhexahydro-1,3,5-triazine, ethylene glycol di(meth)acrylate, propylene glycol di(meth)acrylate, diethylene glycol di(meth)acrylate, triethylene glycol di(meth)acrylate, polyethylene glycol di(meth)acrylate, 1,4-butanediol di(meth)acrylate, 1,6-hexanediol di(meth)acrylate, 1,1,1-trimethylolpropane trimethacrylate, pentaerythritol tri(meth)acrylate, glycerol di(meth)acrylate, glycerol tri(meth)acrylate, triglycerol di(meth)acrylate, allyl (meth)acrylate, vinyl (meth)acrylate, tris [2-(acryloyloxy)ethyl] isocyanurate, or a combination thereof.

A seventeenth embodiment which is the method of any of the proceeding embodiments, wherein the thermally unstable crosslinker comprises triallyl isocyanurate.

An eighteenth embodiment which is the method of any of the proceeding embodiments, wherein the fluid comprises an aqueous fluid, and the thermally unstable crosslinker and the thermally stable crosslinker comprise about 0.001 BWOW to about 10 BWOW, 0.01 BWOW to about 5 BWOW, 0.1 BWOW to about 4 BWOW, about 1 BWOW to about 3 BWOW, about 1 BWOW to about 2 BWOW, about 1.1 BWOW to about 2 BWOW, about 1.2 BWOW to about 2 BWOW, about 1.3 BWOW to about 2 BWOW, about 1.4 BWOW to about 2 BWOW, about 1.5 BWOW to about 2 BWOW, about 1.6 BWOW to about 2 BWOW, about 1.7 BWOW to about 2 BWOW, about 1.8 BWOW to about 2 BWOW, or about 1.9 BWOW to about 2 BWOW of the wellbore treatment fluid.

A nineteenth embodiment which is the method of any of the proceeding embodiments, wherein the thermally stable crosslinker is in an amount ranging from a lower limit of about 0.0001 mol % to about 20 mol %, about 0.001 mol % to about 20 mol %, about 0.01 mol % to about 20 mol %, about 0.1 mol % to about 20 mol %, about 0.15 mol % to about 20 mol %, about 0.2 mol % to about 20 mol %, about 0.25 mol % to about 20 mol %, about 0.3 mol % to about 20 mol %, about 0.35 mol % to about 20 mol %, about 0.4 mol % to about 20 mol %, about 0.45 mol % to about 20 mol %, about 0.5 mol % to about 20 mol %, about 0.55 mol % to about 20 mol %, about 0.6 mol % to about 20 mol %, about 0.65 mol % to about 20 mol %, about 0.7 mol % to about 20 mol %, about 0.75% to about 20 mol %, about 0.8% to about 20 mol %, about 0.85 mol % to about 20 mol %, about 0.9 mol % to about 20 mol %, about 0.95 mol % to about 20 mol %, about 0.0001 mol % to about 2 mol %, about 0.001 mol % to about 2 mol %, about 0.01 mol % to about 2 mol %, about 0.1 mol % to about 2 mol %, about 0.15 mol % to about 2 mol %, about 0.2 mol % to about 2 mol %, about 0.25 mol % to about 2 mol %, about 0.3 mol % to about 2 mol %, about 0.35 mol % to about 2 mol %, about 0.4 mol % to about 2 mol %, about 0.45 mol % to about 2 mol %, about 0.5 mol % to about 2 mol %, about 0.55 mol % to about 2 mol %, about 0.6 mol % to about 2 mol %, about 0.65 mol % to about 2 mol %, about 0.7 mol % to about 2 mol %, about 0.75% to about 2 mol %, about 0.8% to about 2 mol %, about 0.85 mol % to about 2 mol %, about 0.9 mol % to about 2 mol %, about 0.95 mol % to about 2 mol %, about 0.0001 mol % to about 1 mol %, about 0.001 mol % to about 1 mol %, about 0.01 mol % to about 1 mol %, about 0.1 mol % to about 1 mol %, about 0.15 mol % to about 1 mol %, about 0.2 mol % to about 1 mol %, about 0.25 mol % to about 1 mol %, about 0.3 mol % to about 1 mol %, about 0.35 mol % to about 1 mol %, about 0.4 mol % to about 1 mol %, about 0.45 mol % to about 1 mol %, about 0.5 mol % to about 1 mol %, about 0.55 mol % to about 1 mol %, about 0.6 mol % to about 1 mol %, about 0.65 mol % to about 1 mol %, about 0.7 mol % to about 1 mol %, about 0.75% to about 1 mol %, about 0.8% to about 1 mol %, about 0.85 mol % to about 1 mol %, about 0.9 mol % to about 1 mol %, about 0.95 mol % to about 1 mol %, about 1 mol % to about 2 mol %, about 2 mol % to about 3 mol %, about 3 mol % to about 4 mol %, about 4 mol % to about 5 mol %, about 5 mol % to about 10 mol %, about 10 mol % to about 15 mol %, or about 15 mol % to about 20 mol %, based on total moles of suspension reactants.

A twentieth embodiment which is the method of any of the proceeding embodiments, wherein the thermally unstable crosslinker is in an amount ranging from a lower limit of about 0.0001 mol % to about 20 mol %, about 0.001 mol % to about 20 mol %, about 0.01 mol % to about 20 mol %, about 0.1 mol % to about 20 mol %, about 0.15 mol % to about 20 mol %, about 0.2 mol % to about 20 mol %, about 0.25 mol % to about 20 mol %, about 0.3 mol % to about 20 mol %, about 0.35 mol % to about 20 mol %, about 0.4 mol % to about 20 mol %, about 0.45 mol % to about 20 mol %, about 0.5 mol % to about 20 mol %, about 0.55 mol % to about 20 mol %, about 0.6 mol % to about 20 mol %, about 0.65 mol % to about 20 mol %, about 0.7 mol % to about 20 mol %, about 0.75% to about 20 mol %, about 0.8% to about 20 mol %, about 0.85 mol % to about 20 mol %, about 0.9 mol % to about 20 mol %, about 0.95 mol % to about 20 mol %, about 0.0001 mol % to about 2 mol %, about 0.001 mol % to about 2 mol %, about 0.01 mol % to about 2 mol %, about 0.1 mol % to about 2 mol %, about 0.15 mol % to about 2 mol %, about 0.2 mol % to about 2 mol %, about 0.25 mol % to about 2 mol %, about 0.3 mol % to about 2 mol %, about 0.35 mol % to about 2 mol %, about 0.4 mol % to about 2 mol %, about 0.45 mol % to about 2 mol %, about 0.5 mol % to about 2 mol %, about 0.55 mol % to about 2 mol %, about 0.6 mol % to about 2 mol %, about 0.65 mol % to about 2 mol %, about 0.7 mol % to about 2 mol %, about 0.75% to about 2 mol %, about 0.8% to about 2 mol %, about 0.85 mol % to about 2 mol %, about 0.9 mol % to about 2 mol %, about 0.95 mol % to about 2 mol %, about 0.0001 mol % to about 1 mol %, about 0.001 mol % to about 1 mol %, about 0.01 mol % to about 1 mol %, about 0.1 mol % to about 1 mol %, about 0.15 mol % to about 1 mol %, about 0.2 mol % to about 1 mol %, about 0.25 mol % to about 1 mol %, about 0.3 mol % to about 1 mol %, about 0.35 mol % to about 1 mol %, about 0.4 mol % to about 1 mol %, about 0.45 mol % to about 1 mol %, about 0.5 mol % to about 1 mol %, about 0.55 mol % to about 1 mol %, about 0.6 mol % to about 1 mol %, about 0.65 mol % to about 1 mol %, about 0.7 mol % to about 1 mol %, about 0.75% to about 1 mol %, about 0.8% to about 1 mol %, about 0.85 mol % to about 1 mol %, about 0.9 mol % to about 1 mol %, about 0.95 mol % to about 1 mol %, about 1 mol % to about 2 mol %, about 2 mol % to about 3 mol %, about 3 mol % to about 4 mol %, about 4 mol % to about 5 mol %, about 5 mol % to about 10 mol %, about 10 mol % to about 15 mol %, or about 15 mol % to about 20 mol %, based on total moles of suspension reactants.

A twenty-first embodiment which is the method of any of the proceeding embodiments, wherein the at least one monomer is from about 0.1 mole % to about 99.9 mole %, about 0.1 mole % to about 1 mole %, about 1 mole % to about 5 mole %, about 5 mole % to about 10 mole %, about 10 mole % to about 25 mole %, about 25 mole % to about 50 mole %, about 50 mole % to about 75 mole %, about 75 mole % to about 90 mole %, about 90 mole % to about 99 mole %, or about 99 mole % to about 99.9 mole % based on total moles of suspension reactants.

A twenty-second embodiment which is the method of any of the proceeding embodiments, wherein the at least one monomer comprises a first monomer comprising an acrylamide and a second monomer comprising N-vinylpyrrolidone.

A twenty-third embodiment which is the method of any of the proceeding embodiments, wherein the at least one monomer comprises a first monomer comprising an acrylamide and a second monomer comprising N-vinylpyrrolidone, and the acrylamide and N-vinylpyrrolidone are in a mole ratio of about 0.1:about 99.9, about 1:about 99, about 5:about 95, about 10:about 90, about 20:about 80, about 25:about 75, about 30:about 70, about 40:about 60, or about 50:about 50, or about 99.9:about 0.1, about 99:about 1, about 95:about 5; about 90:about 10, about 80:about 20, about 75:about 25, about 70:about 30, or about 60:about 40.

A twenty-fourth embodiment which is the method of any of the proceeding embodiments, wherein the at least one monomer comprises a first monomer comprising an acrylamide and a second monomer comprising N-vinylpyrrolidone, and the acrylamide and N-vinylpyrrolidone are in a mole ratio of about 80:about 20, about 60:about 40, about 50:about 50, or about 40:about 60.

A twenty-fifth embodiment which is the method of any of the proceeding embodiments, wherein the at least one monomer comprises a first monomer comprising an acrylamide and a second monomer comprising N-vinylpyrrolidone, and the acrylamide and N-vinylpyrrolidone are in a mole ratio of about 60:about 40.

A twenty-sixth embodiment which is the method of any of the proceeding embodiments, wherein the aqueous fluid comprises fresh water, salt water, brine, a produced water, a surface water, or a combination thereof.

A twenty-seventh embodiment which is the method of any of the proceeding embodiments, where the reaction product is formed in a two-phase solvent (e.g., comprising an alkanol and water).

A twenty-eighth embodiment which is the method of the twenty-seventh embodiment, wherein the two-phase solvent comprises a C₃-C₅ alkanol.

A twenty-ninth embodiment which is the method of the twenty-seventh embodiment or twenty-eighth embodiment, wherein the two-phase solvent comprises a butanol.

A thirtieth embodiment which is the method of any of the twenty-seventh embodiment to the twenty-ninth embodiment, wherein the two-phase solvent comprises t-butanol or n-butanol.

A thirty-first embodiment which is the method of any of the twenty-seventh embodiment to the thirtieth embodiment, wherein the two-phase solvent comprises greater than 0, about 1, about 2, about 3, or about 4 and less than or equal to about 10, about 9, about 8, about 7, about 6, or about 5 volume percent water based on a total volume of the two-phase solvent.

A thirty-second embodiment which is the method of any of the twenty-seventh embodiment to the thirty-first embodiment, wherein the two-phase solvent comprises greater than or equal to about 0.10, about 0.20, about 0.30, about 0.40, about 0.50, about 1.0, about 1.5, about 2.0, about 2.5, about 3.0, about 3.5, about 4.0, about 4.5, about 5.0, or about 5.5 and less than or equal to about 5.5, about 6.0, about 6.5, about 7.0, about 7.5, about 8.0, about 8.5, about 9.0, about 9.5, or about 10 volume percent water based on a total volume of the two-phase solvent.

A thirty-third embodiment which is the method of any of the twenty-seventh embodiment to the thirty-second embodiment, wherein the two-phase solvent comprises greater than 0 volume percent and less than or equal to about 10 volume percent water based on the total volume of the two-phase solvent and comprises greater than or equal to about 90 volume percent and less than about 100 volume percent t-butanol or n-butanol based on a total volume of the two-phase solvent.

A thirty-fourth embodiment which is the method of any of the twenty-seventh embodiment to the thirty-third embodiment, wherein the two-phase solvent comprises about 3 to about 5 volume percent water and a balance t-butanol based on a total volume of the two-phase solvent, or about 4 to about 6 volume percent water based on the total volume of the two-phase solvent and a balance n-butanol based on the total volume of the two-phase solvent.

A thirty-fifth embodiment which is the method of any of the proceeding embodiments, wherein the wellbore treatment fluid further comprises a cement selected from the group consisting of portland cement, slag cement, pozzolana cement, gypsum cement, aluminous cement, a silica cement, and combinations thereof.

A thirty-sixth embodiment which is the method of any of the proceeding embodiments, wherein the wellbore treatment fluid further comprises a scouring material selected from the group consisting of pumice, perlite, volcanic glass, fumed silica, fly ash, and combinations thereof.

A thirty-seventh embodiment which is a method for preparing a wellbore treatment fluid, comprises contacting a fluid with a high temperature suspension additive to form the wellbore treatment fluid, wherein the high temperature suspension additive is prepared by: (i) contacting at least one monomer and at least one crosslinker comprising a thermally unstable crosslinker and a thermally stable crosslinker comprising a compound with at least four functional groups with a two-phase solvent to form a mixture; and (ii) reacting the at least one monomer and the at least one crosslinker of the mixture in a reaction zone under conditions suitable to produce the high temperature suspension additive.

A thirty-eighth embodiment which is the method of thirty-seventh embodiment, wherein the high temperature suspension additive maintains a viscosity of the wellbore treatment fluid at a temperature of at least 250° F. (121° C.) for at least about 4 hours with a viscosity no less than about 25%, about 13%, or about 9.0% of a peak viscosity.

A thirty-ninth embodiment which is a method for preparing a wellbore treatment fluid comprising contacting a fluid with a high temperature suspension additive to form the wellbore treatment fluid, wherein the high temperature suspension additive has a moiety with a chemical structure:

[A]ₓ-[C]_{y}

wherein:
A is a pentaerythritol moiety, a ethylenediamine moiety, a tetraallylammonium moiety, or a disaccharide moiety;
C is, independently, a propylene, an isobutylene, optionally substituted by an oxo group, or an ether linkage acting as a bond to an adjacent group;
x is an integer equal to or greater than 10; and
y is an integer ranging from 4 to 16.

A fortieth embodiment which is a method, comprises contacting a fluid with a high temperature suspension additive to form a treatment fluid, wherein the high temperature suspension additive is a reaction product of at least one monomer, a thermally unstable crosslinker, and a thermally stable crosslinker comprising a compound with at least four functional groups, wherein at least some of the four functional groups provide cross-linking of the monomer in a polymer chain; and placing the treatment fluid downhole.

A forty-first embodiment which is the method of the fortieth embodiment, further comprising displacing a fluid downhole during the placing of the treatment fluid.

A forty-second embodiment which is the method of the fortieth embodiment or forty-first embodiment, wherein the treatment fluid is placed downhole into a wellbore and/or a subterranean formation.

A forty-third embodiment which is the method of any of the fortieth embodiment to the forty-second embodiment, wherein the high temperature suspension additive is operable at a temperature of about 275° F. (135° C.) to about 550° F. (288° C.).

A forty-fourth embodiment which is the method of any of the fortieth embodiment to the forty-third embodiment, wherein the treatment fluid is a spacer fluid.

A forty-fifth embodiment which is the method of any of the fortieth embodiment to the forty-fourth embodiment, wherein the treatment fluid further comprises a cement selected from the group consisting of a portland cement, a slag cement, a pozzolana cement, a gypsum cement, an aluminous cement, a silica cement, and combinations thereof.

A forty-sixth embodiment which is the method of any of the fortieth embodiment to the forty-fifth embodiment, wherein the treatment fluid further comprises a material selected from the group consisting of a pumice, a perlite, a volcanic glass, a fumed silica, a fly ash, and combinations thereof.

A forty-seventh embodiment which is a method, comprises contacting high temperature suspension additive, water, and a cement blend to form a wellbore servicing fluid at a location proximate a wellsite, wherein the high temperature suspension additive comprises a polymer product of an acrylamide, N-vinylpyrrolidone, triallyl isocyanurate, and pentaerythritol tetraallyl ether in a two-phase solvent to form a suspension which has a property of maintaining viscosity of a wellbore treatment fluid at a temperature of at least 250° F. (121° C.) for at least about 4 hours with a viscosity no less than about 25%, about 13%, or about 9.0% of a peak viscosity; placing the wellbore servicing fluid in a wellbore penetrating a subterranean formation; and allowing the wellbore servicing fluid to set.

A forty-eighth embodiment which is a wellbore treatment fluid, comprises: a fluid; and a high temperature suspension additive comprising a polymer product of a monomer, a thermally unstable crosslinker and a thermally stable crosslinker, which has a property of maintaining viscosity of the wellbore treatment fluid at a temperature of at least 250° F. (121° C.) for at least about 4 hours with a viscosity no less than about 25%, about 13% less than a peak viscosity.

A forty-ninth embodiment, which is a wellbore treatment fluid, comprises: a fluid; and a high temperature suspension additive having a moiety with a chemical structure:

[A]ₓ-[C]_{y}

wherein:
A is a pentaerythritol moiety, a ethylenediamine moiety, a tetraallylammonium moiety, or a disaccharide moiety;
C is, independently, a propylene, an isobutylene, optionally substituted by an oxo group, or an ether linkage acting as a bond to an adjacent group;
x is an integer equal to or greater than 10; and
y is an integer ranging from 4 to 16.

A fiftieth embodiment which is a composition, comprises: at least one monomer and at least one crosslinker comprising a thermally unstable crosslinker and a thermally stable crosslinker in a two-phase solvent to form a suspension, wherein the thermally stable crosslinker comprises a compound with at least four functional groups.

A fifty-first embodiment which is the composition of the fiftieth embodiment, wherein the compound with at least four functional groups comprises pentaerythritol tetra(meth)acrylate, pentaerythritol tetraallyl ether, allyl sucrose, tetraallylethylene diamine, tetraallylammonium chloride, tetraallyl orthosilicate, 1,3,5,7-tetravinyl-1,3,5,7-tetramethylcyclotetrasiloxane, or a combination thereof.

A fifty-second embodiment which is the composition of the fiftieth embodiment or fifty-first embodiment, wherein the compound with at least four functional groups comprises pentaerythritol tetraallyl ether.

A fifty-third embodiment which is the composition of any of the fiftieth embodiment to fifty-second embodiment, wherein the thermally unstable crosslinker comprises at least one functional group and not more than three functional groups.

A fifty-fourth embodiment which is the composition of any of the fiftieth embodiment to fifty-third embodiment, wherein the thermally unstable crosslinker comprises triallyl isocyanurate, N, N-methylenebisacrylamide, divinyl ether, diallyl ether, ethylene glycol divinyl ether, triethylene glycol divinyl ether, diethylene glycol divinyl ether, glycerol diallyl ether, polyethylene glycol divinyl ether, propylene glycol divinyl ether, trimethylolpropane diallyl ether, divinylbenzene, 1,3-divinylimidazolidin-2-one, divinyltetrahydropyrimidin-2 (1H)-one, a diene, an allyl amine, N,N′-methylenebismethacrylamide, N,N′-ethylenebisacrylamide, N,N′-propylenebisacrylamide, N,N′-(1,2-dihydroxyethylene)bisacrylamide, 1,4-diacryloylpiperazine, N,N-diallylacrylamide, 1,3,5-triacryloylhexahydro-1,3,5-triazine, ethylene glycol di(meth)acrylate, propylene glycol di(meth)acrylate, diethylene glycol di(meth)acrylate, triethylene glycol di(meth)acrylate, polyethylene glycol di(meth)acrylate, 1,4-butanediol di(meth)acrylate, 1,6-hexanediol di(meth)acrylate, 1,1,1-trimethylolpropane trimethacrylate, pentaerythritol tri(meth)acrylate, glycerol di(meth)acrylate, glycerol tri(meth)acrylate, triglycerol di(meth)acrylate, allyl (meth)acrylate, vinyl (meth)acrylate, tris [2-(acryloyloxy)ethyl] isocyanurate, or a combination thereof.

A fifty-fifth embodiment which is the composition of any of the fiftieth embodiment to fifty-fourth embodiment, wherein the thermally unstable crosslinker comprises triallyl isocyanurate.

A fifty-sixth embodiment which is the composition of any of the fiftieth embodiment to fifty-fifth embodiment, wherein the at least one crosslinker comprises about 0.001 BWOW to about 10 BWOW, 0.01 BWOW to about 5 BWOW, 0.1 BWOW to about 4 BWOW, about 1 BWOW to about 3 BWOW, about 1 BWOW to about 2 BWOW, about 1.1 BWOW to about 2 BWOW, about 1.2 BWOW to about 2 BWOW, about 1.3 BWOW to about 2 BWOW, about 1.4 BWOW to about 2 BWOW, about 1.5 BWOW to about 2 BWOW, about 1.6 BWOW to about 2 BWOW, about 1.7 BWOW to about 2 BWOW, about 1.8 BWOW to about 2 BWOW, or about 1.9 BWOW to about 2 BWOW of the wellbore treatment fluid.

A fifty-seventh embodiment which is the composition of any of the fiftieth embodiment to fifty-sixth embodiment, wherein the thermally stable crosslinker is in an amount ranging from a lower limit of about 0.0001 mol % to about 20 mol %, about 0.001 mol % to about 20 mol %, about 0.01 mol % to about 20 mol %, about 0.1 mol % to about 20 mol %, about 0.15 mol % to about 20 mol %, about 0.2 mol % to about 20 mol %, about 0.25 mol % to about 20 mol %, about 0.3 mol % to about 20 mol %, about 0.35 mol % to about 20 mol %, about 0.4 mol % to about 20 mol %, about 0.45 mol % to about 20 mol %, about 0.5 mol % to about 20 mol %, about 0.55 mol % to about 20 mol %, about 0.6 mol % to about 20 mol %, about 0.65 mol % to about 20 mol %, about 0.7 mol % to about 20 mol %, about 0.75% to about 20 mol %, about 0.8% to about 20 mol %, about 0.85 mol % to about 20 mol %, about 0.9 mol % to about 20 mol %, about 0.95 mol % to about 20 mol %, about 0.0001 mol % to about 2 mol %, about 0.001 mol % to about 2 mol %, about 0.01 mol % to about 2 mol %, about 0.1 mol % to about 2 mol %, about 0.15 mol % to about 2 mol %, about 0.2 mol % to about 2 mol %, about 0.25 mol % to about 2 mol %, about 0.3 mol % to about 2 mol %, about 0.35 mol % to about 2 mol %, about 0.4 mol % to about 2 mol %, about 0.45 mol % to about 2 mol %, about 0.5 mol % to about 2 mol %, about 0.55 mol % to about 2 mol %, about 0.6 mol % to about 2 mol %, about 0.65 mol % to about 2 mol %, about 0.7 mol % to about 2 mol %, about 0.75% to about 2 mol %, about 0.8% to about 2 mol %, about 0.85 mol % to about 2 mol %, about 0.9 mol % to about 2 mol %, about 0.95 mol % to about 2 mol %, about 0.0001 mol % to about 1 mol %, about 0.001 mol % to about 1 mol %, about 0.01 mol % to about 1 mol %, about 0.1 mol % to about 1 mol %, about 0.15 mol % to about 1 mol %, about 0.2 mol % to about 1 mol %, about 0.25 mol % to about 1 mol %, about 0.3 mol % to about 1 mol %, about 0.35 mol % to about 1 mol %, about 0.4 mol % to about 1 mol %, about 0.45 mol % to about 1 mol %, about 0.5 mol % to about 1 mol %, about 0.55 mol % to about 1 mol %, about 0.6 mol % to about 1 mol %, about 0.65 mol % to about 1 mol %, about 0.7 mol % to about 1 mol %, about 0.75% to about 1 mol %, about 0.8% to about 1 mol %, about 0.85 mol % to about 1 mol %, about 0.9 mol % to about 1 mol %, about 0.95 mol % to about 1 mol %, about 1 mol % to about 2 mol %, about 2 mol % to about 3 mol %, about 3 mol % to about 4 mol %, about 4 mol % to about 5 mol %, about 5 mol % to about 10 mol %, about 10 mol % to about 15 mol %, or about 15 mol % to about 20 mol %, based on total moles of suspension reactants.

A fifty-eighth embodiment which is the composition of any of the fiftieth embodiment to fifty-seventh embodiment, wherein the thermally unstable crosslinker is in an amount ranging from a lower limit of about 0.0001 mol % to about 20 mol %, about 0.001 mol % to about 20 mol %, about 0.01 mol % to about 20 mol %, about 0.1 mol % to about 20 mol %, about 0.15 mol % to about 20 mol %, about 0.2 mol % to about 20 mol %, about 0.25 mol % to about 20 mol %, about 0.3 mol % to about 20 mol %, about 0.35 mol % to about 20 mol %, about 0.4 mol % to about 20 mol %, about 0.45 mol % to about 20 mol %, about 0.5 mol % to about 20 mol %, about 0.55 mol % to about 20 mol %, about 0.6 mol % to about 20 mol %, about 0.65 mol % to about 20 mol %, about 0.7 mol % to about 20 mol %, about 0.75% to about 20 mol %, about 0.8% to about 20 mol %, about 0.85 mol % to about 20 mol %, about 0.9 mol % to about 20 mol %, about 0.95 mol % to about 20 mol %, about 0.0001 mol % to about 2 mol %, about 0.001 mol % to about 2 mol %, about 0.01 mol % to about 2 mol %, about 0.1 mol % to about 2 mol %, about 0.15 mol % to about 2 mol %, about 0.2 mol % to about 2 mol %, about 0.25 mol % to about 2 mol %, about 0.3 mol % to about 2 mol %, about 0.35 mol % to about 2 mol %, about 0.4 mol % to about 2 mol %, about 0.45 mol % to about 2 mol %, about 0.5 mol % to about 2 mol %, about 0.55 mol % to about 2 mol %, about 0.6 mol % to about 2 mol %, about 0.65 mol % to about 2 mol %, about 0.7 mol % to about 2 mol %, about 0.75% to about 2 mol %, about 0.8% to about 2 mol %, about 0.85 mol % to about 2 mol %, about 0.9 mol % to about 2 mol %, about 0.95 mol % to about 2 mol %, about 0.0001 mol % to about 1 mol %, about 0.001 mol % to about 1 mol %, about 0.01 mol % to about 1 mol %, about 0.1 mol % to about 1 mol %, about 0.15 mol % to about 1 mol %, about 0.2 mol % to about 1 mol %, about 0.25 mol % to about 1 mol %, about 0.3 mol % to about 1 mol %, about 0.35 mol % to about 1 mol %, about 0.4 mol % to about 1 mol %, about 0.45 mol % to about 1 mol %, about 0.5 mol % to about 1 mol %, about 0.55 mol % to about 1 mol %, about 0.6 mol % to about 1 mol %, about 0.65 mol % to about 1 mol %, about 0.7 mol % to about 1 mol %, about 0.75% to about 1 mol %, about 0.8% to about 1 mol %, about 0.85 mol % to about 1 mol %, about 0.9 mol % to about 1 mol %, about 0.95 mol % to about 1 mol %, about 1 mol % to about 2 mol %, about 2 mol % to about 3 mol %, about 3 mol % to about 4 mol %, about 4 mol % to about 5 mol %, about 5 mol % to about 10 mol %, about 10 mol % to about 15 mol %, or about 15 mol % to about 20 mol %, based on total moles of suspension reactants.

A fifty-ninth embodiment which is the composition of any of the fiftieth embodiment to fifty-eighth embodiment, wherein the at least one monomer is from about 0.1 mole % to about 99.9 mole %, about 0.1 mole % to about 1 mole %, about 1 mole % to about 5 mole %, about 5 mole % to about 10 mole %, about 10 mole % to about 25 mole %, about 25 mole % to about 50 mole %, about 50 mole % to about 75 mole %, about 75 mole % to about 90 mole %, about 90 mole % to about 99 mole %, or about 99 mole % to about 99.9 mole % based on total moles of suspension reactants.

A sixtieth embodiment which is the composition of any of the fiftieth embodiment to fifty-ninth embodiment, wherein the at least one monomer comprises a first monomer comprising an acrylamide and a second monomer comprising N-vinylpyrrolidone.

A sixty-first embodiment which is the composition of any of the fiftieth embodiment to sixtieth embodiment, wherein the at least one monomer comprises a first monomer comprising an acrylamide and a second monomer comprising N-vinylpyrrolidone, and the acrylamide and N-vinylpyrrolidone are in a mole ratio of about 0.1:about 99.9, about 1:about 99, about 5:about 95, about 10:about 90, about 20:about 80, about 25:about 75, about 30:about 70, about 40:about 60, or about 50:about 50, or about 99.9:about 0.1, about 99:about 1, about 95:about 5; about 90:about 10, about 80:about 20, about 75:about 25, about 70:about 30, or about 60:about 40.

A sixty-second embodiment which is the composition of any of the fiftieth embodiment to sixty-first embodiment, wherein the at least one monomer comprises a first monomer comprising an acrylamide and a second monomer comprising N-vinylpyrrolidone, and the acrylamide and N-vinylpyrrolidone are in a mole ratio of about 80:about 20, about 60:about 40, about 50:about 50, or about 40:about 60.

A sixty-third embodiment which is the composition of any of the fiftieth embodiment to sixty-second embodiment, wherein the at least one monomer comprises a first monomer comprising an acrylamide and a second monomer comprising N-vinylpyrrolidone, and the acrylamide and N-vinylpyrrolidone are in a mole ratio of about 60:about 40.

A sixty-fourth embodiment which is the composition of any of the fiftieth embodiment to sixty-third embodiment, wherein the two-phase solvent comprises an alkanol and water.

A sixty-fifth embodiment, which is a composition, comprises at least one monomer and at least one crosslinker comprising a thermally unstable crosslinker and a thermally stable crosslinker in a two-phase solvent to form a suspension, wherein after activation of the crosslinker to achieve a peak viscosity after a yield point, a suspension maintains a viscosity no less than about 25%, about 13%, or about 9.0% less than the peak viscosity for at least about 2, or about 4 hours.

A sixty-sixth embodiment, which is the composition of the sixty-fifth embodiment, wherein the peak viscosity after the yield point occurs at a temperature of at least about 100° F. (38° C.), about 150° F. (66° C.), about 200° F. (93° C.), about 250° F. (121° C.), about 300° F. (149° C.), about 350° F. (177° C.), or about 390° F. (199° C.).

A sixty-seventh embodiment, which is the composition of the sixty-fifth embodiment or sixty-sixth embodiment, wherein the thermally unstable crosslinker comprises at least one functional group and not more than three functional groups.

A sixty-eighth embodiment, which is the composition of any of the sixty-fifth embodiment to sixty-seventh embodiment, wherein the thermally stable crosslinker comprises a compound with at least four functional groups.

A sixty-ninth embodiment, which is a method, comprises preparing a high temperature suspension additive, comprising contacting an acrylamide, N-vinylpyrrolidone, triallyl isocyanurate, and pentaerythritol tetraallyl ether in a two-phase solvent to form a suspension; and reacting the acrylamide and the N-vinylpyyrolidone to produce the high temperature suspension additive, wherein the high temperature suspension additive maintains viscosity of a wellbore treatment fluid at a temperature of at least 250° F. (121° C.) for at least about 4 hours with a viscosity no less than about 25%, about 13%, or about 9.0% of a peak viscosity.

A seventieth embodiment which is a high temperature suspension additive, comprises a polymer product of acrylamide, N-vinylpyyrolidone, thermally unstable crosslinkers comprising N, N-methylenebisacrylamide and triallyl isocyanurate, and a thermally stable crosslinker comprising pentaerythritol tetraallyl ether polymerized in a two-phase solvent, wherein the high temperature suspension additive maintains viscosity of a wellbore treatment fluid at a temperature of at least 250° F. (121° C.) for at least about 4 hours with a viscosity no less than about 25%, about 13%, or about 9.0% of a peak viscosity.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. While numerous changes may be made by those skilled in the art, such changes are encompassed within the spirit of the subject matter defined by the appended claims. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. In particular, every range of values (e.g., “from about a to about b,” or, equivalently, “from approximately a to b,” or, equivalently, “from approximately a-b”) disclosed herein is to be understood as referring to the power set (the set of all subsets) of the respective range of values. The terms in the claims have their plain, ordinary meaning unless otherwise explicitly and clearly defined by the patentee.

What is claimed is:

1. A method for preparing a wellbore treatment fluid comprising:
contacting a fluid with a high temperature suspension additive to form the wellbore treatment fluid,
wherein the high temperature suspension additive is a reaction product of at least one monomer, a thermally unstable crosslinker, and a thermally stable crosslinker comprising a compound with at least four functional groups, and
wherein the high temperature suspension additive maintains a viscosity of the wellbore treatment fluid at a temperature of at least 250° F. (121° C.) for at least about 4 hours with a viscosity equal to or greater than about 25% of a peak viscosity.

2. The method of claim 1, wherein the monomer polymerizes to provide a plurality of polymer chains and wherein at least some of the four functional groups provide cross-linking of the polymer chains.

3. The method of claim 1, wherein some of the thermally stable crosslinker forms at least four single bonds with adjacent groups.

4. The method of claim 1, wherein the thermally stable crosslinker has a chemical formula:
[A]-[B]_{y}
wherein:
A is a pentaerythritol moiety, a ethylenediamine moiety, a tetraallylammonium moiety, or a disaccharide moiety;
B is, independently, a propenyl or an isobutenyl, optionally substituted by an oxo group; and
y is an integer ranging from 4 to 16.

5. The method of claim 4, wherein y is an integer ranging from 4 to 8.

6. The method of claim 4, wherein the disaccharide moiety is a sucrose moiety, a lactose moiety, a maltose moiety, a trehalose moiety, a cellobiose moiety, a chitobiose moiety, or a combination thereof.

7. The method of claim 4, wherein the disaccharide moiety comprises a sucrose moiety.

8. The method of claim 1, wherein the high temperature suspension additive has an operative temperature range greater than a high temperature suspension additive crosslinked with a thermally stable crosslinker absent a compound with at least four functional groups.

9. The method of claim 1, wherein the temperature has a lower limit of about 250° F. (121° C.) to an upper limit of about 550° F. (288° C.).

10. The method of claim 1, further comprising placing the wellbore treatment fluid downhole with a bottom hole static temperature (BHST) ranging from a lower limit of about 250° F. (121° C.) to an upper limit of about 550° F. (288° C.).

11. The method of claim 1, wherein the thermally stable crosslinker has a formula: 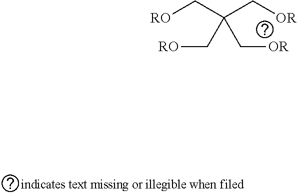
wherein R is

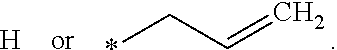

12. The method of claim 1, wherein the compound with the at least four functional groups comprises pentaerythritol, pentaerythritol tetra(meth)acrylate, pentaerythritol tetraallyl ether, allyl sucrose, tetraallylethylene diamine, tetraallylammonium chloride, tetraallyl orthosilicate, 1,3,5,7-tetravinyl-1,3,5,7-tetramethylcyclotetrasiloxane, or a combination thereof.

13. The method of claim 1, wherein the compound with the at least four functional groups comprises pentaerythritol tetraallyl ether.

14. The method of claim 1, wherein the thermally unstable crosslinker comprises at least one functional group and not more than three functional groups.

15. The method of claim 1, wherein the thermally unstable crosslinker comprises triallyl isocyanurate, N, N-methylenebisacrylamide, divinyl ether, diallyl ether, ethylene glycol divinyl ether, triethylene glycol divinyl ether, diethylene glycol divinyl ether, glycerol diallyl ether, polyethylene glycol divinyl ether, propylene glycol divinyl ether, trimethylolpropane diallyl ether, divinylbenzene, 1,3-divinylimidazolidin-2-one, divinyltetrahydropyrimidin-2 (1H)-one, a diene, an allyl amine, N,N′-methylenebismethacrylamide, N,N′-ethylenebisacrylamide, N,N′-propylenebisacrylamide, N,N′-(1,2-dihydroxyethylene)bisacrylamide, 1,4-diacryloylpiperazine, N,N-diallylacrylamide, 1,3,5-triacryloylhexahydro-1,3,5-triazine, ethylene glycol di(meth)acrylate, propylene glycol di(meth)acrylate, diethylene glycol di(meth)acrylate, triethylene glycol di(meth)acrylate, polyethylene glycol di(meth)acrylate, 1,4-butanediol di(meth)acrylate, 1,6-hexanediol di(meth)acrylate, 1,1,1-trimethylolpropane trimethacrylate, pentaerythritol tri(meth)acrylate, glycerol di(meth)acrylate, glycerol tri(meth)acrylate, triglycerol di(meth)acrylate, allyl (meth)acrylate, vinyl (meth)acrylate, tris [2-(acryloyloxy)ethyl] isocyanurate, or a combination thereof.

16. A method for preparing a wellbore treatment fluid comprising:
contacting a fluid with a high temperature suspension additive to form the wellbore treatment fluid,
wherein the high temperature suspension additive has a moiety with a chemical structure:
[A]ₓ-[C]_{y}
wherein:
A is a pentaerythritol moiety, a ethylenediamine moiety, a tetraallylammonium moiety, or a disaccharide moiety;
C is, independently, a propylene, an isobutylene, optionally substituted by an oxo group, or an ether linkage acting as a bond to an adjacent group;
x is an integer equal to or greater than 10; and
y is an integer ranging from 4 to 16.

17. A method, comprising:
contacting a fluid with a high temperature suspension additive to form a treatment fluid,
wherein the high temperature suspension additive is a reaction product of at least one monomer, a thermally unstable crosslinker, and a thermally stable crosslinker comprising a compound with at least four functional groups, wherein at least some of the four functional groups provide cross-linking of the monomer in a polymer chain; and
placing the treatment fluid downhole.

18. The method of claim 17, further comprising displacing a fluid downhole during the placing of the treatment fluid.

19. The method of claim 17, wherein the treatment fluid is placed downhole into a wellbore and/or a subterranean formation.

20. The method of claim 17, wherein the high temperature suspension additive is operable at a temperature of about 275° F. (135° C.) to about 550° F. (288° C.).
